(19) United States
(12) Patent Application Publication
(10) Pub. No.: US 2026/0084119 A1
(43) Pub. Date: Mar. 26, 2026

(54) NANOSTRUCTURED TiO2 LOADED GRAPHENE SHEETS COATED CERAMIC MEMBRANE AND METHOD OF PREPARATION THEREOF

(71) Applicant: KING FAHD UNIVERSITY OF PETROLEUM AND MINERALS, Dhahran (SA)

(72) Inventor: Umair BAIG, Dhahran (SA)

(73) Assignee: KING FAHD UNIVERSITY OF PETROLEUM AND MINERALS, Dhahran (SA)

(21) Appl. No.: 18/898,436

(22) Filed: Sep. 26, 2024

(51) Int. Cl. B01D 71/02; B01D 69/10; C10G 33/06

(52) U.S. Cl. CPC B01D 71/025; B01D 69/108; B01D 71/0211; C10G 33/06

(57) ABSTRACT

A membrane including an aluminum oxide ceramic support coated with a layer including graphene flakes and titanium dioxide nanoparticles. The titanium dioxide nanoparticles are dispersed on the graphene flakes, and the titanium dioxide nanoparticles dispersed on the graphene flakes are in the form of spherical particles. The spherical particles have a diameter of 1 micrometer (μm) to 15 μm and the graphene flakes have a longest dimension of 0.2 μm to 5 μm.

### STATEMENT REGARDING PRIOR DISCLOSURE BY THE INVENTORS

Aspects of the present disclosure are described in Baig, U. and Dastageer, M. A., “Facile fabrication of nanostructured titanium dioxide loaded graphene sheets coated ceramic membrane with superhydrophilic and underwater superoleophobic nature for water treatment” published in Volume 58, Results in Physics, which is incorporated herein by reference in its entirety.

### STATEMENT OF ACKNOWLEDGEMENT

Support provided by the Interdisciplinary Research Center for Membranes and Water Security, King Fahd University of Petroleum and Minerals, Saudi Arabia, through Project INMW2213 is gratefully acknowledged.

### BACKGROUND

### Technical Field

The present disclosure is directed toward fabricating membranes, particularly nanostructured TiO₂-loaded graphene sheets-coated ceramic membranes.

### Description of Related Art

The “background” description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Common sources of mixing oil and water in the petrochemical industry include oil excavation by pouring water into aged oil wells, seeping of oil pipelines, and accidental oil leakage during transportation. Generation of oily water by such means is a cause of environmental concern and further renders water unusable. Various physical, chemical, and biological methods have been used for the bulk removal of oil phases from water phases; however, these techniques fail to remove oil in low concentrations (for example, micro-sized droplets) dispersed in recovered water medium (oil-in-water emulsion) and water in low concentrations (for example, micro-sized droplets) dispersed in recovered oil (water-in-oil emulsion). In membrane-based micro filtration processes, oil droplets can pass through pores even though the pore size is smaller than that of the oil droplets. An alternative method for use of membranes for oil-water separation is to coat and/or modify the membrane support with oil and water wettability materials to selectively reject oil or water droplets.

Membrane surfaces with materials showing a combination of wettability for oil and water, owing to engineered surface chemistry and surface topology, have been fabricated and used for oil-water separation. Various functionalized polymeric and ceramic membranes showing superhydrophobic and superoleophilic combinations of wettability have been used in oil-water separation processes. The functionalized polymeric and ceramic membranes show a water contact angle between 150° and 160° with good flux and oil-water separation efficiency; however, a major constraint of using membranes with this kind of wettability is the lack of recyclability due to the oil-passing nature of the membrane and the consequent rapid clogging of oil in the membrane pores. A different type of membrane showing a superhydrophilic and underwater superoleophobic combination of wettability has been fabricated using inorganic metal oxide-based polymers and silane-based polymer cross-linked materials and used for oil-water separation. An advantage of this type of surface is that it is oil-reducing and water-passing; therefore, oil clogging is minimized, resulting in a high level of recyclability by retaining the original oil-water separation efficiency after prolonged use.

Graphene is a material that shows a wide range of contact angles corresponding to hydrophilicity and hydrophobicity. Although graphene is non-polar due to sp² hybridization in the C—C bonds, mild polarity arises from p-hydrogen bonding, surface defects, and partial wetting transparency. Partial wetting transparency, surface defects, and p-hydrogen bonding may contribute to the mild hydrophilicity of graphene; however, under normal working conditions, graphene is hydrophobic due to the surface adsorption of ambient hydrocarbons. Derivatives of graphene, such as graphene oxide and reduced graphene oxide, may be hydrophilic due to the polarity arising from the hydroxyl, carboxyl, carbonyl, and epoxy functional groups. Graphene-based membrane coating materials have been synthesized by engineering the surface wettability of graphene, graphene oxide, and reduced graphene oxide, for use in oil-water separation.

Present methods and sources of fabricating superhydrophilic and superoleophobic membranes are inefficient, detrimental to the environment, and expensive. Accordingly, one object of the present disclosure is to provide a nanostructured titanium dioxide-loaded graphene sheet-coated ceramic membrane that may circumvent drawbacks of the art, such as unfavorable wettability, poor hydrophilic performance, and unfeasible economic aspects.

### SUMMARY

In an exemplary embodiment, a membrane is described. The membrane includes an aluminum oxide ceramic support coated with a layer including graphene flakes and titanium dioxide nanoparticles. The titanium dioxide nanoparticles are dispersed on the graphene flakes, as such, the titanium dioxide nanoparticles dispersed on the graphene flakes are in the form of spherical particles. The spherical particles have a diameter of 1 micrometer (μm) to 15 μm, the graphene flakes have a longest dimension of 0.2 μm to 5 μm.

In another exemplary embodiment, a method of making the above-described membrane is described. The method includes sonicating graphite paint for 30 to 90 minutes to form a graphene dispersion. The method further includes mixing titanium dioxide nanoparticles with a polar organic solvent to form a titanium dioxide dispersion, sonicating the graphene dispersion and the titanium dioxide dispersion for 20 to 40 minutes to form a titanium dioxide nanoparticle loaded graphene sheet nanocomposite dispersion. The method further includes spray coating the titanium dioxide nanoparticle loaded graphene sheet nanocomposite dispersion on the aluminum oxide ceramic support to form the membrane.

In some embodiments, wherein the spray coating is done with a spray gun having a 0.7 millimeters (mm) to 0.8 mm nozzle diameter.

In some embodiments, the spray gun is under nitrogen pressure of 160 kilo Pascals (kPa) to 180 kPa.

In some embodiments, the aluminum oxide support is at a distance of 10 centimeters (cm) to 30 cm from the nozzle.

In some embodiments, the titanium dioxide nanoparticles have an average diameter of 10 nanometers (nm) to 70 nm.

In some embodiments, the membrane includes 50 to 60 percent by weight (wt. %) carbon, 15 to 25 wt. % oxygen, 10 to 20 wt. % titanium, 5 to 10 wt. % aluminum, and 1 to 3 wt. % silicon based on a total weight of the membrane.

In some embodiments, the membrane has a water contact angle in air of 0.0 to 0.1°.

In some embodiments, the membrane has an oil contact angle in air of 0.0 to 0.1°.

In some embodiments, the membrane has an oil contact angle in water of 158 to 162°.

In some embodiments, the membrane has a pure water flux of 210 liters per square meter per hour (L m⁻² h⁻¹) to 230 L m⁻² h⁻¹ at a pressure of 1 bar.

In yet another exemplary embodiment, a method of filtration is described. The method includes contacting the above-described membrane with a mixture. The mixture includes one or more oils and water. The method further includes passing a filtrate through the membrane and collecting the filtrate; as such, the filtrate has a lower amount of the one or more oils than the mixture.

In some embodiments, the one or more oils are present in the mixture at a concentration of 50 parts per million (ppm) to 500 ppm.

In some embodiments, the one or more oils are present in the mixture at a concentration of 100 ppm, and the membrane has a flux of 140 to 160 L m⁻² h⁻¹ at a pressure of 1 bar.

In some embodiments, the one or more oils are selected from a group consisting of motor oil, diesel oil, and crude oil.

In some embodiments, the method of filtration further includes applying a pressure to the membrane.

In some embodiments, a hydration layer forms on a surface of the membrane.

In some embodiments, the one or more oils is motor oil, and the membrane has a flux of 140 to 160 L m⁻² h⁻¹ at a pressure of 1 bar and a concentration of motor oil of 100 ppm.

In another exemplary embodiment, one or more oils is diesel oil, and the membrane has a flux of 100 to 120 L m⁻² h⁻¹ at a pressure of 1 bar and a concentration of diesel oil of 100 ppm.

In some embodiments, the membrane has an oil from water separation efficiency of 97 to 100 percent based on an initial weight of the oil.

These and other aspects of the non-limiting embodiments of the present disclosure will become apparent to those skilled in the art upon review of the following description of specific non-limiting embodiments of the disclosure in conjunction with the accompanying drawings. The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure (including alternatives and/or variations thereof) and many of the attendant advantages thereof will be readily obtained as the same becomes better understood by reference to the following detailed description when considered in connection with the accompanying drawings, wherein:

FIG. 1A is a flowchart illustrating a method of making a membrane, according to certain embodiments.

FIG. 1B is a flowchart illustrating a filtration method, according to certain embodiments.

FIG. 1C is a schematic diagram of a method of preparing a titanium dioxide-loaded graphene sheet (TiO₂@GS) nanocomposite using an ultrasound-assisted synthesis, according to certain embodiments.

FIG. 2 is a schematic diagram of a method of preparing a TiO₂@GS-coated aluminum oxide (Al₂O₃) ceramic membrane using a spray coating method, according to certain embodiments.

FIG. 3A depicts an X-ray diffraction (XRD) pattern of an aluminum oxide (Al₂O₃) support, according to certain embodiments.

FIG. 3B depicts an XRD pattern of a graphene sheet (GS)-coated Al₂O₃ support, according to certain embodiments.

FIG. 3C depicts an XRD pattern of the TiO₂@GS-coated Al₂O₃ ceramic membrane, according to certain embodiments.

FIG. 4A depicts attenuated total reflectance Fourier-transform infrared (ATR-FTIR) spectra of the Al₂O₃ support_{,} the GS-coated Al₂O₃ support, and the TiO₂@GS-coated Al₂O₃ ceramic membrane from 400 cm⁻¹ to 4000 cm⁻¹, according to certain embodiments.

FIG. 4B depicts ATR-FTIR spectra of the Al₂O₃ support, the GS-coated Al₂O₃ support, and the TiO₂@GS-coated Al₂O₃ ceramic membrane from 400 cm⁻¹ to 1400 cm⁻¹, according to certain embodiments.

FIG. 5A is a scanning electron microscopy (SEM) image of the Al₂O₃ support with a scale of 10 micrometers (μm), according to certain embodiments.

FIG. 5B is an SEM image of the Al₂O₃ support with a scale of 5 μm, according to certain embodiments.

FIG. 5C is an SEM image of the Al₂O₃ support with a scale of 500 nanometers (nm), according to certain embodiments.

FIG. 5D is an SEM image of the GS-coated Al₂O₃ support with a scale of 10 μm, according to certain embodiments.

FIG. 5E is an SEM image of the GS-coated Al₂O₃ support with a scale of 5 μm, according to certain embodiments.

FIG. 5F is an SEM image of the GS-coated Al₂O₃ support with a scale of 500 nm, according to certain embodiments.

FIG. 5G is an SEM image of the TiO₂@GS-coated Al₂O₃ ceramic membrane with a scale of 10 μm, according to certain embodiments.

FIG. 5H is an SEM image of the TiO₂@GS-coated Al₂O₃ ceramic membrane with a scale of 5 μm, according to certain embodiments.

FIG. 5I is an SEM image of the TiO₂@GS-coated Al₂O₃ ceramic membrane with a scale of 500 nm, according to certain embodiments.

FIG. 6A is a transmission electron microscopy (TEM) image of the GS-coated Al₂O₃ support, according to certain embodiments.

FIG. 6B is a high-resolution transmission electron microscopy (HR-TEM) image of the GS-coated Al₂O₃ support, according to certain embodiments.

FIG. 6C is a selected area electron diffraction (SAED) image of the GS-coated Al₂O₃ support, according to certain embodiments.

FIG. 6D is a TEM image of the TiO₂@GS-coated Al₂O₃ ceramic membrane, according to certain embodiments.

FIG. 6E is a HR-TEM image of the TiO₂@GS-coated Al₂O₃ ceramic membrane, according to certain embodiments.

FIG. 6F is a SAED image of the TiO₂@GS-coated Al₂O₃ ceramic membrane, according to certain embodiments.

FIG. 7A is an SEM image of the Al₂O₃ support, according to certain embodiments.

FIG. 7B depicts an energy-dispersive X-ray (EDX or EDS) analysis of the Al₂O₃ support, according to certain embodiments.

FIG. 7C is an SEM image of the GS-coated Al₂O₃ support, according to certain embodiments.

FIG. 7D depicts an EDX analysis of the GS-coated Al₂O₃ support, according to certain embodiments.

FIG. 7E is an SEM image of the TiO₂@GS-coated Al₂O₃ ceramic membrane, according to certain embodiments.

FIG. 7F depicts an EDX analysis of the TiO₂@GS-coated Al₂O₃ ceramic membrane, according to certain embodiments.

FIG. 8A is an energy-dispersive X-ray (EDS or EDX) layered image depicting elemental mapping analysis of the Al₂O₃ support, according to certain embodiments.

FIG. 8B is an EDS image depicting the presence of oxygen (O) in the elemental mapping analysis of the Al₂O₃ support, according to certain embodiments.

FIG. 8C is an EDS image depicting the presence of aluminum (Al) in the elemental mapping analysis of the Al₂O₃ support, according to certain embodiments.

FIG. 8D is an EDS image depicting the presence of silicon (Si) in the elemental mapping analysis of the Al₂O₃ support, according to certain embodiments.

FIG. 8E is an EDS-layered image depicting elemental mapping analysis of the GS-coated Al₂O₃ support, according to certain embodiments.

FIG. 8F is an EDS image depicting the presence of carbon (C) in the elemental mapping analysis of the GS-coated Al₂O₃ support, according to certain embodiments.

FIG. 8G is an EDS image depicting the presence of O in the elemental mapping analysis of the GS-coated Al₂O₃ support, according to certain embodiments.

FIG. 8H is an EDS image depicting the presence of Al in the elemental mapping analysis of the GS-coated Al₂O₃ support, according to certain embodiments.

FIG. 8I is an EDS image depicting the presence of Si in the elemental mapping analysis of the GS-coated Al₂O₃ support, according to certain embodiments.

FIG. 8J is an EDS-layered image depicting elemental mapping analysis of the TiO₂@GS-coated Al₂O₃ ceramic membrane, according to certain embodiments.

FIG. 8K is an EDS image depicting the presence of C in the elemental mapping analysis of the TiO₂@GS-coated Al₂O₃ ceramic membrane, according to certain embodiments.

FIG. 8L is an EDS image depicting the presence of O in the elemental mapping analysis of TiO₂@GS-coated Al₂O₃ ceramic membrane, according to certain embodiments.

FIG. 8M is an EDS image depicting the presence of Al in the elemental mapping analysis of the TiO₂@GS-coated Al₂O₃ ceramic membrane, according to certain embodiments.

FIG. 8N is an EDS image depicting the presence of Si in the elemental mapping analysis of the TiO₂@GS-coated Al₂O₃ ceramic membrane, according to certain embodiments.

FIG. 8O is an EDS image depicting the presence of titanium (Ti) in the elemental mapping analysis of the TiO₂@GS-coated Al₂O₃ ceramic membrane, according to certain embodiments.

FIG. 9A shows contact angle analysis of the GS-coated Al₂O₃ support and the TiO₂@GS-coated Al₂O₃ ceramic membrane in water in air, oil in air and oil under water, according to certain embodiments.

FIG. 9B is a contact angle image of the GS-coated Al₂O₃ support for water in air, according to certain embodiments.

FIG. 9C is a contact angle image of the GS-coated Al₂O₃ support for oil in air, according to certain embodiments.

FIG. 9D is a contact angle image of the GS-coated Al₂O₃ support for oil under water, according to certain embodiments.

FIG. 9E is a contact angle image of the TiO₂@GS-coated Al₂O₃ ceramic membrane for water in air, according to certain embodiments.

FIG. 9F is a contact angle image of the TiO₂@GS-coated Al₂O₃ ceramic membrane for oil in air, according to certain embodiments.

FIG. 9G is a contact angle image of the TiO₂@GS-coated Al₂O₃ ceramic membrane for oil under water, according to certain embodiments.

FIG. 10 depicts the effect of trans-membrane pressure on pure water flux of the TiO₂@GS-coated Al₂O₃ ceramic membrane, according to certain embodiments.

FIG. 11A shows the effect of the oil concentration in a diesel oil-in-water emulsion on the permeate flux of the TiO₂@GS-coated Al₂O₃ ceramic membrane at a pressure of 1 bar, according to certain embodiments.

FIG. 11B shows oil-water separation efficiency of the TiO₂@GS-coated Al₂O₃ ceramic membrane in a diesel oil-in-water emulsion at a pressure of 1 bar, according to certain embodiments.

FIG. 12A shows the effect of different oils in oil-in-water emulsions on permeate flux of the TiO₂@GS-coated Al₂O₃ ceramic membrane, according to certain embodiments.

FIG. 12B shows oil-water separation efficiency of the TiO₂@GS-coated Al₂O₃ ceramic membrane, according to certain embodiments.

FIG. 13A is an image of the diesel oil-in-water emulsion feed, according to certain embodiments.

FIG. 13B depicts the diesel oil-in-water emulsion feed and permeate, according to certain embodiments.

FIG. 13C is an image of a permeate sample from the diesel oil-in-water emulsion after contact with the TiO₂@GS-coated Al₂O₃ ceramic membrane, according to certain embodiments.

FIG. 13D is an image of a motor oil-in-water emulsion feed, according to certain embodiments.

FIG. 13E depicts the motor oil-in-water emulsion feed and permeate, according to certain embodiments.

FIG. 13F is an image of a permeate sample from the motor oil-in-water emulsion after contact with the TiO₂@GS-coated Al₂O₃ ceramic membrane, according to certain embodiments.

FIG. 13G is an image of a crude oil-in-water emulsion feed, according to certain embodiments.

FIG. 13H depicts the crude oil-in-water emulsion feed and permeate, according to certain embodiments.

FIG. 13I is an image of a permeate sample from the crude oil-in-water emulsion after contact with the TiO₂@GS-coated Al₂O₃ ceramic membrane, according to certain embodiments.

FIG. 14 is a schematic illustration depicting a mechanism of surface wettability-based remediation of water from oil-in-water emulsions using the TiO₂@GS-coated Al₂O₃ ceramic membrane, according to certain embodiments.

### DETAILED DESCRIPTION

In the following description, it is understood that other embodiments may be utilized, and structural and operational changes may be made without departure from the scope of the present embodiments disclosed herein.

Reference will now be made to specific embodiments or features, examples of which are illustrated in the accompanying drawings. In the drawings, whenever possible, corresponding or similar reference numerals will be used to designate identical or corresponding parts throughout the several views. Moreover, references to various elements described herein are made collectively or individually when there may be more than one element of the same type. However, such references are merely exemplary in nature. It may be noted that any reference to elements in the singular may also be constructed to relate to the plural and vice-versa without limiting the scope of the disclosure to the exact number or type of such elements unless set forth explicitly in the appended claims. Further, as used herein, the words “a,” “an,” and the like generally carry a meaning of “one or more,”unless stated otherwise.

Furthermore, the terms “approximately,” “approximate,” “about,” and similar terms generally refer to ranges that include the identified value within a margin of 20%, 10%, or preferably 5%, and any values therebetween.

As used herein, the term “membrane” refers to a porous structure that is capable of separating components of a homogeneous or heterogeneous fluid. A membrane may be a layer of varying thickness of semi-permeable material that may be used for solute separation as a transmembrane pressure is applied across the membrane. A degree of selectivity may be based on membrane composition, charge, and porosity. Membranes may have symmetric or asymmetric pores, wherein a membrane with asymmetric pores have variable pore diameters. Membranes may be used for microfiltration, ultrafiltration, nanofiltration, and reverse osmosis process. In particular, “pores” in the sense of the present disclosure indicate voids allowing fluid communication between different sides of the structure. Pores may have a varying pore size, pore size distribution, and pore morphology, such as pore shape and surface roughness. The pores may be made up of a network of interconnected channels. More particular in use when a homogeneous or heterogeneous fluid is passed through the membrane, some components of the fluid can pass through the pores of the membrane into a “permeate stream,” while some components of the fluid can be retained by the membrane and can thus accumulate in a “retentate,” and/or some components of the fluid can be rejected by the membrane into a “rejection stream. ” Membranes can be of various thicknesses, with homogeneous or heterogeneous structures. Membranes can be in the form of flat sheets or bundles of hollow fibers. Membranes can also be in various configurations including, but not limited to, spiral wound, tubular, hollow fiber, and other configurations identifiable to a skilled person upon a reading of the present disclosure. Membranes can also be classified according to their pore diameter. Membranes can be neutral or charged, and particle transport can be active or passive. The latter can be facilitated by pressure, concentration, and chemical or electrical gradients of the membrane process.

As used herein, the term “filtration” refers to the mechanical or physical operation or process which can be used for separating components of homogeneous or heterogeneous solutions. Filtration may use a filter medium to separate components of homogeneous and heterogenous solutions. The filter medium may be a physical separator, such as a membrane, a chemical separator or gradient, an electrical separator or gradient, and any separator or gradient known in the art for separating solutions. Filtration may be used to separate solids from liquids, solids from gases, and/or liquids from other liquids. Filtration may be gravity-driven, pressure-driven, and/or vacuum-driven.

As used herein, the term “pure water flux” refers to the flow rate of pure water through a membrane. This term is often used in membrane filtration processes, such as ultrafiltration and reverse osmosis. In these processes, membranes are used to separate contaminants or solutes from water, allowing only water molecules to pass through. The pure water flux is a parameter in evaluating the performance of these membranes, as it indicates how effectively water can permeate the membrane. It is typically measured in units such as liters per square meter per hour (L/m²·h) or gallons per square foot per day (GFD). High pure water flux is desirable in membrane filtration systems as it can lead to higher water recovery rates and lower operating costs.

Aspects of the present disclosure are directed towards a superhydrophilic and under-water superoleophobic graphene sheet (GS) loaded with TiO₂ nanoparticle material. The TiO₂-loaded graphene was spray-coated on an Al₂O₃ ceramic substrate to obtain a membrane (designated as TiO₂@GS-coated Al₂O₃ ceramic membrane). The membrane was further evaluated for its potential in separating an oil-in-water emulsion. The membrane of the present disclosure demonstrates a high separation efficiency, increased permeate flux, and reduced oil clogging in the pores of the membrane for increased the recyclability of the membrane during prolonged use.

According to the first aspect of the present disclosure, a membrane is disclosed. The membrane includes two components—i) an aluminum oxide ceramic support (support); and ii) graphene flakes and titanium dioxide nanoparticles coated on the support. The support includes a ceramic substrate coated with and/or comprising aluminum oxide/alumina particles to form an aluminum oxide ceramic support (support). Alumina, in most embodiments, is alpha-alumina (α-Al₂O₃), aluminum(III) oxide, or Al₂O₃ particles, in the support. These particles may be microsized or nanosized alumina particles. In some embodiments, the alumina content in the support typically ranges from 50 to 100 wt. % of the unsintered starting materials. In some embodiments, the alumina content in the support is at least 50 wt. %, 55 wt. %, 60 wt. %, 65 wt. %, 70 wt. %, 75 wt. %, 80 wt. %, 85 wt. %, 90 wt. %, 95 wt. %, 99 wt. %, or 100 wt. % of the support or any intermediate value of subrange.

In some embodiments, the support is porous and may have any suitable pore size. The pores of the support may have the same or different pore sizes. The support may be a microporous membrane, a mesoporous membrane, a nanoporous membrane, or an ultrafiltration membrane. In some embodiments, the pore size of the support layer may be from 0.1 nm to 4000 nm, preferably 1 to 3000 nm, preferably 10 to 2000 nm, preferably 50 to 1000 nm, or preferably 100 to 500 nm. In some embodiments, the pore size of the support is smaller than the average size of the particles of graphene flakes or TiO₂ nanoparticles. For example, should the graphene oxide be in the form of flakes having an average size of 500 nm, the pore size of the support is preferably smaller than 500 nm.

The support may have any suitable thickness. In some embodiments, the thickness of the support may be between 5 and 125 μm, preferably between 5 and 100 μm, preferably between 10 to 100 μm, preferably between 30 and 100 μm, preferably between 30 and 90 μm, preferably between 30 and 85 μm, preferably between 30 and 70 μm, or preferably between 30 and 60 μm.

The membrane further includes a layer including graphene flakes and titanium dioxide nanoparticles (also referred to as “layer”) coated on the support. In an embodiment, the support is deposited partially or wholly in at least one layer in a uniform and continuous manner. In some embodiments, a surface of the support is at least 50 %, preferably 60 %, preferably 70 %, preferably 80 %, preferably 90 %, preferably 95 %, more preferably 99 %, and yet more preferably about 100 % covered by the layer including graphene flakes and titanium dioxide nanoparticles. In an embodiment, the layer including graphene flakes and titanium dioxide nanoparticles forms a monolayer on the support. In another embodiment, the layer including graphene flakes and titanium dioxide nanoparticles may include more than one layer, for example, 2-15 layers, preferably 3-13 layers, or preferably 5-10 layers, on the support.

The titanium dioxide nanoparticles are dispersed on and/or in the graphene flakes. In some embodiments, the titanium dioxide nanoparticles dispersed on and/or in the graphene flakes are in the form of spherical particles. In other embodiments, the titanium dioxide nanoparticles dispersed on and/or in the graphene flakes may be in the form of square particles, rectangular particles, triangular particals, polygonal particles, rod-shaped particles, and any other particle shape known in the art. In some embodiments, the geometry of the graphene flakes may include, but is not limited to, a circular, polygonal, triangular, rectangular, and the like. In some embodiments, the titanium dioxide nanoparticles dispersed on and/or in the graphene flakes are in the form of spherical particles and have a diameter of 1 to 15 micrometers (μm), preferably 2 to 14 μm, preferably 3 to 13 μm, preferably 4 to 12 μm, preferably 5 to 11 μm, preferably 6 to 10 μm, and preferably 7 to 9 μm. In some embodiments, the graphene flakes have a longest dimension of 0.2 to 5 μm, preferably 0.5 to 4 μm, and preferably 1 to 3 μm. In some embodiments, the titanium dioxide nanoparticles have an average diameter of 10 to 70 nanometers (nm), preferably 20 to 60 nm, preferably 25 to 50 nm, and preferably 30 to 40 nm.

In some embodiments, the membrane includes carbon in an amount of 50 to 60 percent by weight (wt. %), preferably 52 to 59 wt. %, more preferably 54 to 58 wt. %, and yet more preferably about 56.2 wt. %, oxygen in an amount of 15 to 25 wt. %, preferably 17 to 23 wt. %, more preferably 19 to 21 wt. %, and yet more preferably about 20.4 wt. %, titanium in an amount of 10 to 20 wt. %, preferably 12 to 16 wt. %, more preferably 13 to 15 wt. %, and yet more preferably about 14.4 wt. %, aluminum in an amount of 5 to 10 wt. %, preferably 6 to 9 wt. %, more preferably 7 to 8 wt. %, and yet more preferably about 7.4 wt. %, and silicon in an amount of 1 to 3 wt. %, preferably 1.2 to 2 wt. %, more preferably 1.5 to 2 wt. %, and yet more preferably about 1.7 wt. % based on the total weight of the membrane.

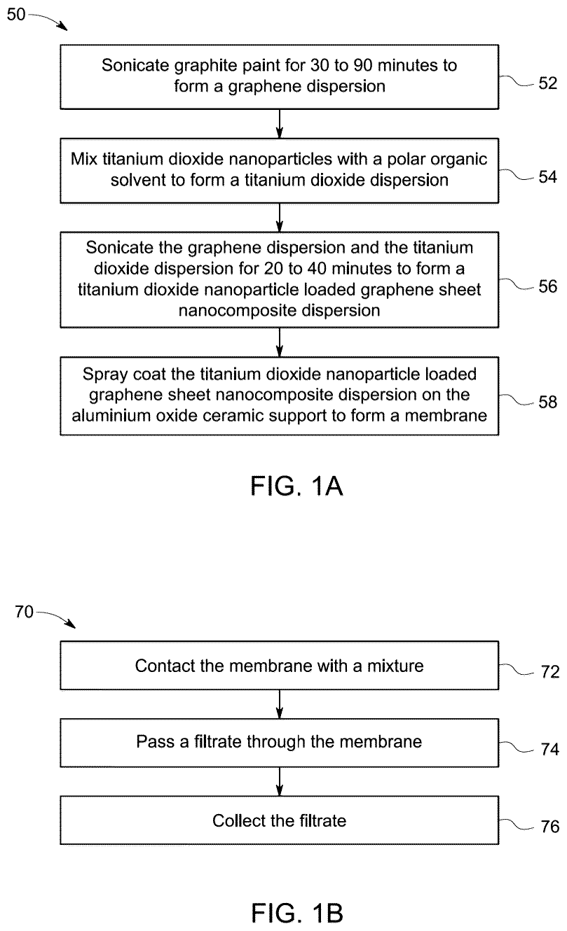

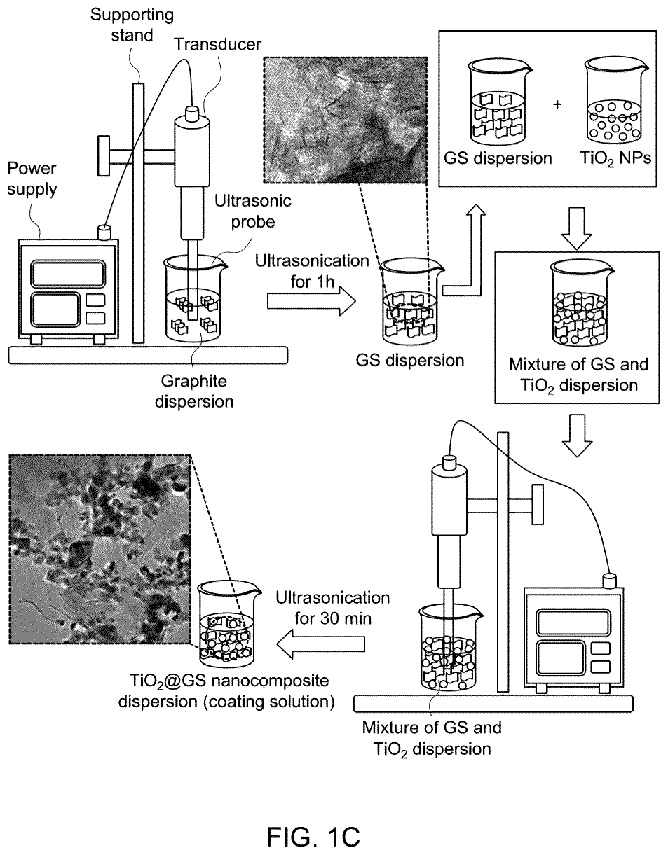

FIG. 1A illustrates a flow chart of a method 50 of making the membrane. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes sonicating graphite paint for 30 to 90 minutes, more preferably 40 to 70 minutes, and yet more preferably about 60 minutes, to form a graphene dispersion. The graphite paint is a graphite material used as a source to obtain graphene. In some embodiments, other graphitic materials, such as natural graphite, synthetic graphite, highly oriented pyrolytic graphite (HOPG), graphite fiber, graphite rods, graphite minerals, graphite powder, and chemically modified graphite may be used in place of or in combination with the graphite paint. In some embodiments, the graphite paint may be mixed in a solvent, preferably an organic solvent, preferably a polar organic solvent, or more preferably, a polar aprotic organic solvent (for example, acetone) prior to sonication.

In some embodiments, sonication is carried out at a frequency of 10-30 kHz, preferably 15 to 25 kHz, and more preferably about 20 kHz, and a power is 500-1000 watts, preferably 600-900 watts, more preferably 700-800 watts, and yet more preferably about 750 watts. Sonication results in the exfoliation of graphite layers in the graphite material, or any other graphitic material, to obtain graphene. In some embodiments, other modes of agitation known to those of ordinary skill in the art, for example, via stirring, swirling, mixing, or a combination thereof, may be employed to form the graphene dispersion.

At step 54, the method 50 includes mixing titanium dioxide nanoparticles with a polar organic solvent to form a titanium dioxide dispersion. In some embodiments, the organic solvent may include, but is not limited to, tetrahydrofuran, ethyl acetate, dimethylformamide, acetonitrile, acetone, dimethyl sulfoxide, nitromethane, propylene carbonate, ethanol, formic acid, n-butanol, methanol, benzene, cyclohexane, ethanol, methanol, acetone, ethyl acetate, dichloromethane, toluene, diethyl ether, and/or combinations thereof. In some embodiments, the organic solvent is a polar aprotic solvent, preferably acetone. In some embodiments, the mixing can be done by any methods known in the art, including stirring, swirling, sonicating, or a combination thereof, to form the titanium dioxide dispersion.

At step 56, method 50 includes mixing the graphene dispersion with the titanium dioxide dispersion and sonicating the graphene and titanium dioxide dispersion for 20 to 40 minutes, preferably 25 to 35 minutes, and more preferably about 30 minutes, to form a titanium dioxide nanoparticle loaded graphene sheet nanocomposite dispersion.

At step 58, the method 50 includes spray coating the titanium dioxide nanoparticle loaded graphene sheet nanocomposite dispersion on the aluminum oxide ceramic support to form a membrane. In some embodiments, spray coating can be substituted by electrostatic spraying, spin casting, dipping, painting, dripping, brushing, immersing, flowing, exposing, electrostatic spraying, pouring, rolling, curtaining, wiping, printing, pipetting, inkjet printing, and the like. In some embodiments, the spray coating is done with a spray gun having a 0.7 millimeters (mm) to 0.8 mm, more preferably 0.72 to 0.78 mm, and more preferably about 0.75 mm nozzle diameter. In some embodiments, the spray coating is carried out in an inert atmosphere, preferably nitrogen, at a pressure of 160 kilo Pascals (kPa) to 180 kPa, more preferably 165 to 175 kPa, and more preferably about 170 kPa. Several factors influence the coating thickness of the nanocomposite on the aluminum oxide ceramic support, one of which is the spraying distance. In some embodiments, the aluminum oxide support is kept at a distance of 10 centimeters (cm) to 30 cm, more preferably 15 to 25 cm, and yet more preferably about 20 cm from the spray gun.

In some embodiments, the membrane has a water contact angle in air of 0.0 to 0.1°, preferably 0.0 to 0.05°, and preferably 0.0 to 0.02°. As used herein, the term “contact angle” is the angle between a liquid surface and a solid surface where they meet. More specifically, it is the angle between the surface tangent on the liquid-vapor interface and the tangent on the solid-liquid interface at their intersection. Generally, if the water contact angle is less than 90°, the solid surface is considered hydrophilic, and if the water contact angle is greater than 90°, the solid surface is considered hydrophobic. If the water contact angle exceeds 150°, the solid surface is considered superhydrophobic. In some embodiments, the membrane has an oil contact angle in air of 0.0 to 0.1°, preferably 0.0 to 0.05°, and preferably 0.0 to 0.02°. In some embodiments, the membrane has an oil contact angle in water of 158 to 162°, preferably 159 to 161°, and more preferably about 160°. In some embodiments, the membrane has a pure water flux of 210 to 230 L m⁻² h⁻¹, preferably 215 to 225 L m⁻² h⁻¹ at a pressure of 1 bar.

FIG. 1B illustrates a flow chart of a method 70 of filtration. The order in which the method 70 is described is not intended to be construed as a limitation, and any number of the described method steps can be combined in any order to implement the method 70. Additionally, individual steps may be removed or skipped from the method 70 without departing from the spirit and scope of the present disclosure.

At step 72, the method 70 includes contacting the membrane with a mixture. The mixture includes one or more oils and water. The oil(s) may be one or more of toluene, hexane, cyclohexane, dichloromethane, plant oil, isooctane, lubricating oil, motor oil, crude oil, diesel oil, gasoline, and the like. In a preferred embodiment, the oil is one or more of motor oil, crude oil, and diesel oil. In some embodiments, the one or more oils are present in the mixture at a concentration of 50 parts per million (ppm) to 500 ppm, preferably 75 to 450 ppm, preferably 100 to 400 ppm, preferably 150 to 350 ppm, or preferably 200 to 300 ppm. In a preferred embodiment, the one or more oils are present in the mixture at a concentration of about 100 ppm, about 200 ppm, and about 400 ppm. In some embodiments, when the oils are present in the mixture at a concentration of 100 ppm, the membrane has a flux of 140 to 160 L m⁻² h⁻¹ at a pressure of 1 bar. In some embodiments, when the oil is motor oil, the membrane has a flux of 140 to 160 L m⁻² h⁻¹, more preferably 145 to 155 L m⁻² h⁻¹ and yet more preferably 150 L m⁻² h⁻¹ at a pressure of 1 bar and a concentration of motor oil of 100 ppm. In another exemplary embodiment, when the oil is diesel oil, the membrane has a flux of 100 to 120 L m⁻² h⁻¹, preferably 105 to 115 L m⁻² h⁻¹, and preferably 108 to 112 L m⁻² h⁻¹ at a pressure of 1 bar and a concentration of diesel oil of 100 ppm. In some embodiments, contacting the membrane with the mixture forms a hydration layer on the surface of the membrane where the membrane contacts the mixture.

At step 74, method 70 includes passing a filtrate through the membrane. The filtrate is passed through the membrane under a force that may be provided by gravity, vacuum, hydraulic pressure, centrifugal force, or electrostatic force, among others.

At step 76, method 70 includes collecting the filtrate. The filtrate collected has less of the oils than the amount of oil present in the mixture. In some embodiments, the membrane has an oil-from-water separation efficiency of 97 to 100 percent, more preferably 98 to 99.9 percent, and yet more preferably about 99 percent based on the initial weight of the oil.

The membrane of the present disclosure is scalable, cost-effective, and efficient, which makes it an alternative to the existing membranes for use in wastewater treatment plants and various industries, including food and beverage industries, power generation plants, mining industries, chemical manufacturing plants, and the like.

### EXAMPLES

The following examples describe and demonstrate a membrane with an aluminum oxide ceramic support coated with a layer including graphene flakes and titanium dioxide nanoparticles. The examples are provided solely for illustration and are not to be construed as limitations of the present disclosure, as many variations thereof are possible without departing from the spirit and scope of the present disclosure.

### Example 1: Synthesis of Titanium Dioxide Loaded Graphene Sheets (TiO₂@GS) Nanocomposite and Fabrication of TiO₂@GS-Coated Aluminum Oxide (Al₂O₃) Ceramic Membrane

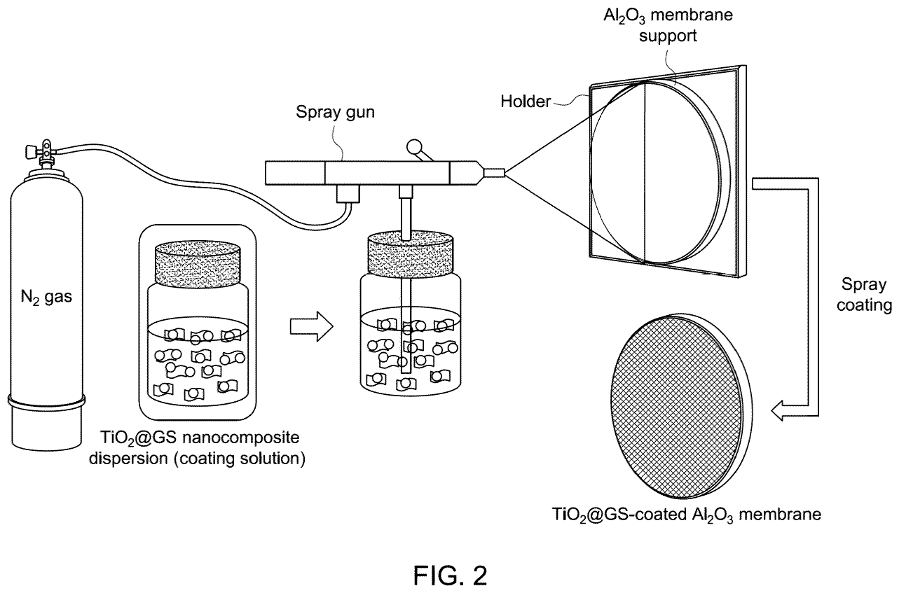

The synthesis process for TiO₂@GS nanocomposite used to coat Al₂O₃ ceramic membrane support is shown in FIG. 1C. Graphene was exfoliated from graphite using an ultrasonic transducer (Sonics, Vibra-Cell™, USA). A precursor graphite paint was diluted with acetone and kept under the ultrasonic transducer. The frequency of the ultrasonic transducer is 20 kiloHertz (kHz) with a power of 750 watts (W). The precursor graphite paint was subjected to ultra-sonication for 60 minutes for graphene dispersion. The dispersion of TiO₂ nanoparticles (99.9 % purity, Sigma) in acetone was separately prepared and mixed with the graphene dispersion. This mixture was further subjected to ultra-sonication for 30 minutes to get the final TiO₂ nanoparticles loaded graphene sheets (TiO₂@GS) nanocomposite. The homogeneous TiO₂@GS nanocomposite dispersion was spray coated on Al₂O₃ ceramic membrane support using a spray gun with 0.75 mm nozzle diameter under the nitrogen pressure of 170 kPa, by keeping the substrate at a distance of 20 cm from the nozzle, as shown in FIG. 2.

### Example 2: Characterizations

For structural analysis, a benchtop X-ray diffractometer (Rigaku XRD, Miniflex 600) was used. The chemical composition was studied using Fourier transform infrared (FTIR) spectroscopy with a Thermo Fisher Scientific ATR-FTIR, Nicolet iS-50. Scanning electron microscopy (SEM) with an EDX option (JEOL SEM/EDX, JSM6610LV) and transmission electron microscopy (TEM) (JEOL FE-TEM, JEM2100F) were used for morphological, structural, and elemental studies. A drop-shape analyzer (KRUSS, DSA25) was used to measure contact angles.

### Example 3: Separation of Oil-In-Water Emulsion

For evaluating the efficiency of oil-in-water emulsion separation using the TiO₂@GS-coated Al₂O₃ ceramic membrane, a dead-end membrane filtration system (Sterlitech, USA) was used. The test feed solutions are of three concentrations (100 parts per million (ppm), 200 ppm, and 400 ppm) of motor oil-in-water, diesel oil-in-water, and crude oil-in-water emulsions. These oil-in-water emulsions were prepared by mixing the respective oil and water with sodium dodecyl sulfate (SDS) surfactant using a shear mixer at 30000 revolutions per minute (rpm), and the effects of permeate flux and oil-in-water emulsion separation efficiency on trans-membrane pressure and oil concentrations were evaluated.

### Example 4: Structural and Chemical Characterization of Membranes

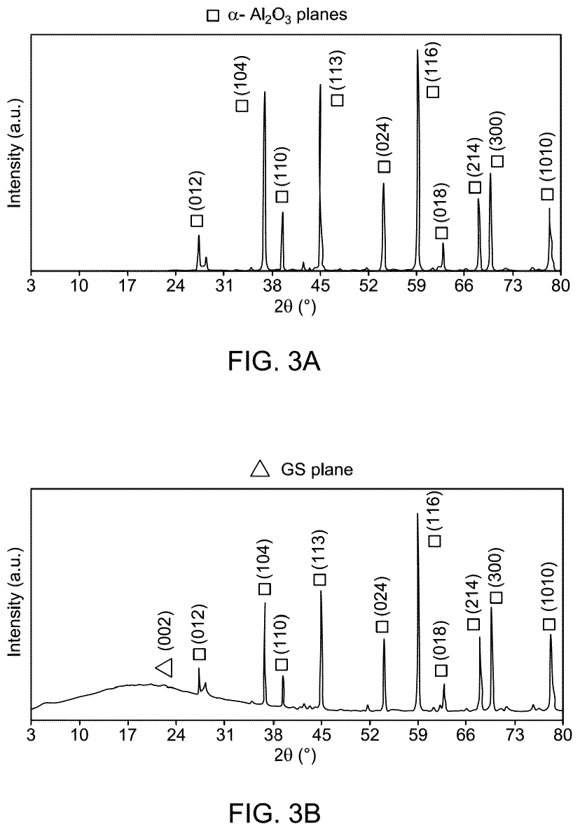

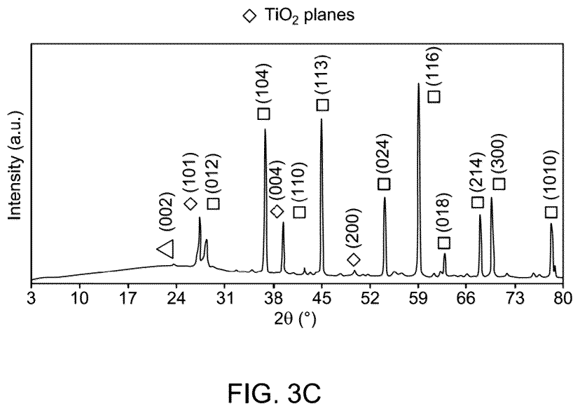

X-ray diffraction (XRD) patterns of the Al₂O₃ ceramic substrate, the GS-coated Al₂O₃, support, and the TiO₂@GS-coated Al₂O₃ ceramic membrane are shown in FIGS. 3A-3C. XRD pattern of the Al₂O₃ ceramic substrate, as depicted in FIG. 3A, is typical for the hexagonal crystal structure of aluminum oxide (α-Al₂O₃). The presence of broad and weak XRD peak corresponding to (002) plane centered at 2θ=21° in FIG. 3B, the absence of the typical graphene oxide peak at 2θ=11.5°, and the presence of the typical sharp peak of graphite at 2θ=21° supports the derivative of carbon that resulted due to the exfoliation of graphite is graphene. FIG. 3C shows the XRD pattern of the TiO₂@GS-coated Al₂O₃ ceramic membrane. The anatase phase of TiO₂ is identified by the strong peaks corresponding to the (101), (004), and (200) planes at 2θ=25.3°, 25.3°, and 58.3°, respectively. In FIG. 3C, the peak corresponding to the (101) plane of anatase TiO₂ overlaps with the (012) plane of Al₂O₃ at 25.4°, and the peak corresponding to the (004) peak of anatase TiO2 overlaps with the (110) plane of Al₂O₃ at 38°; however, the presence of a distinct (200) peak of anatase TiO₂ at 48° supports the presence of TiO₂. In addition, in FIG. 3C, the broad (002) plane of graphene is also retained.

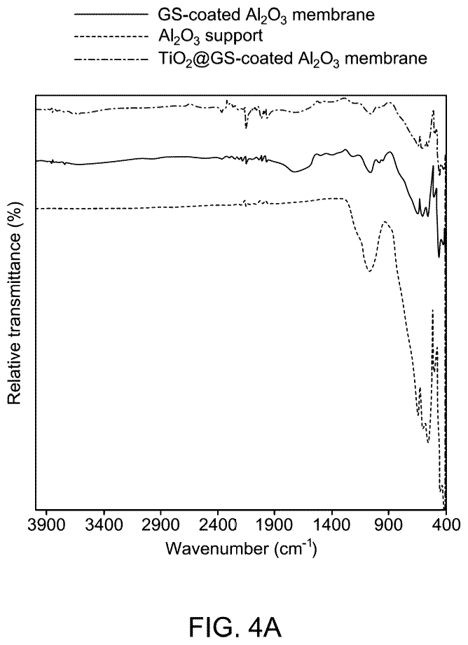

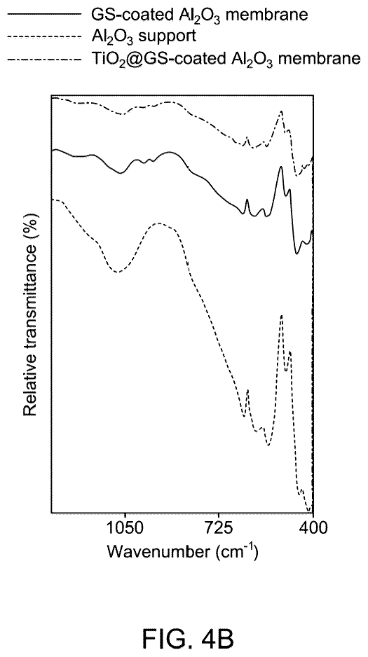

FIGS. 4A-4B depict the ATR-FTIR spectra of Al₂O₃ support, the GS-coated Al₂O₃ support, and the TiO₂@GS-coated Al₂O₃ ceramic membrane in the 400 cm⁻¹ to 4000 cm⁻¹ spectral region. For the Al₂O₃ support, the observed peaks at 459 cm⁻¹, 595 cm⁻¹, and 656 cm⁻¹ are due to the Al—O stretching mode of vibrations, and a broad peak in 900 cm⁻¹ to 1100 cm⁻¹ region is due to O—H vibrations. When pure graphene is loaded on the Al₂O₃ support, a C═C peak around 1700 cm⁻¹ appears along with the peaks ascribed to Al₂O₃, with lower prominence. In the case of TiO₂@GS-coated Al₂O₃ ceramic membrane, the FTIR spectrum does not reveal the characteristic Ti—O peaks below 1000 cm⁻¹, which could be overwhelmed by the intensity of other peaks in the region; however, a small peak at around 2400 cm⁻¹ may be attributed to the vibrations originating from bonds between TiO₂ and the graphene or the Al₂O₃ support.

### Example 5: Morphological Characterizations of the Membranes

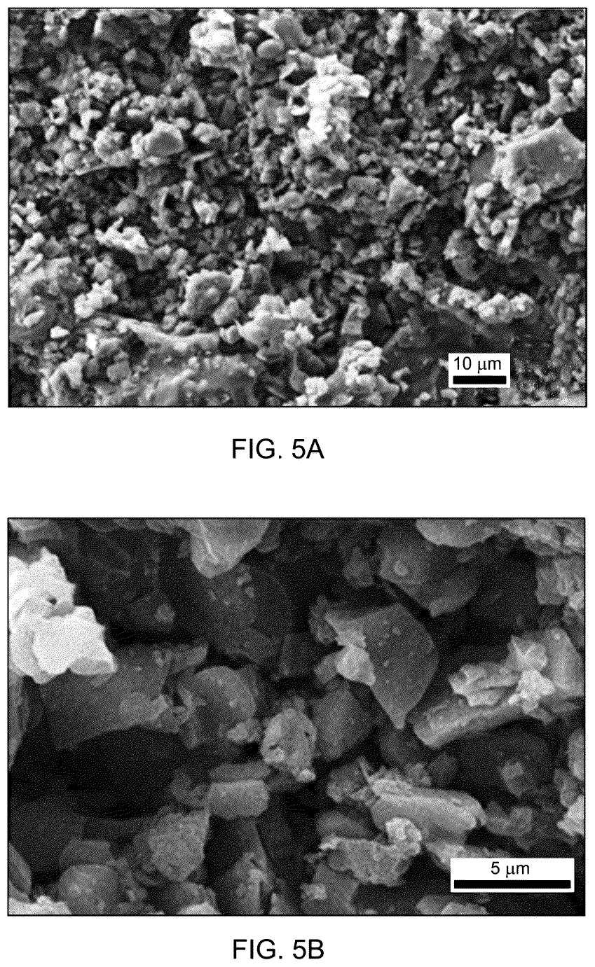

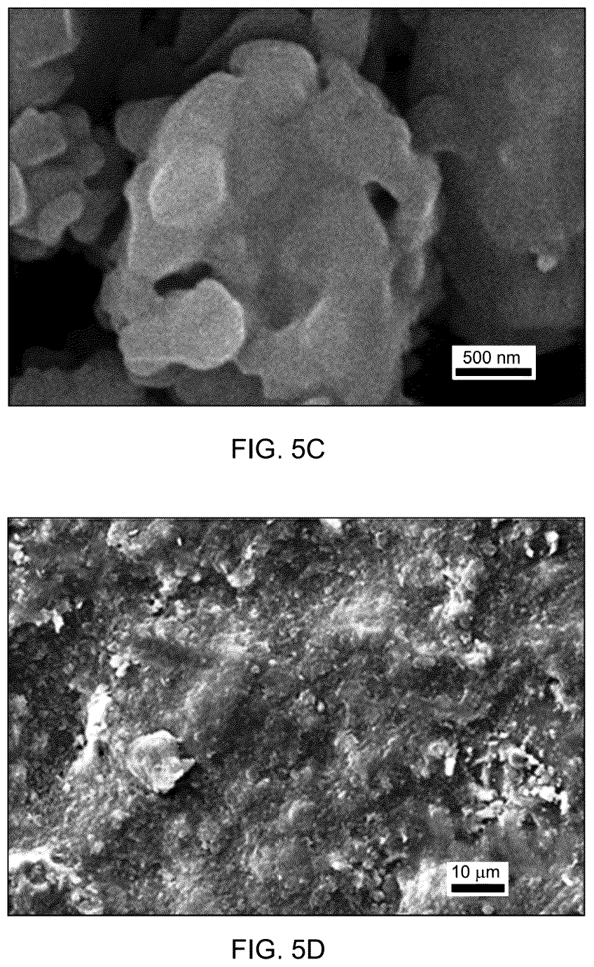

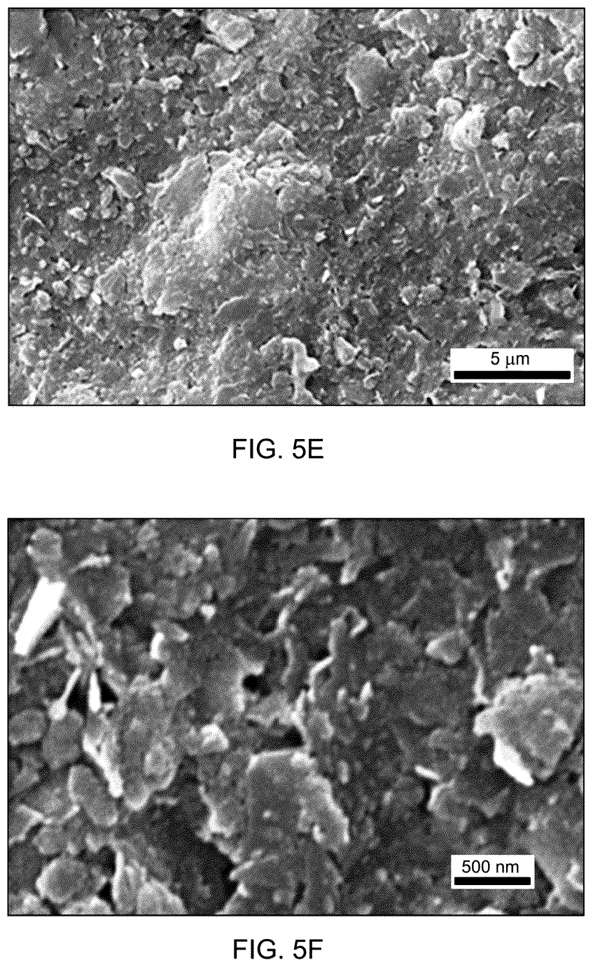

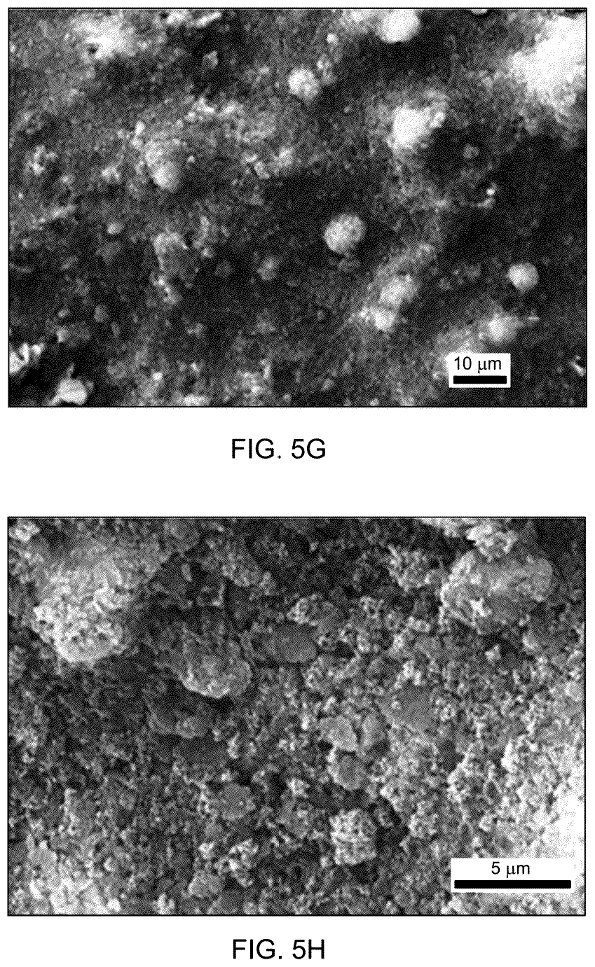

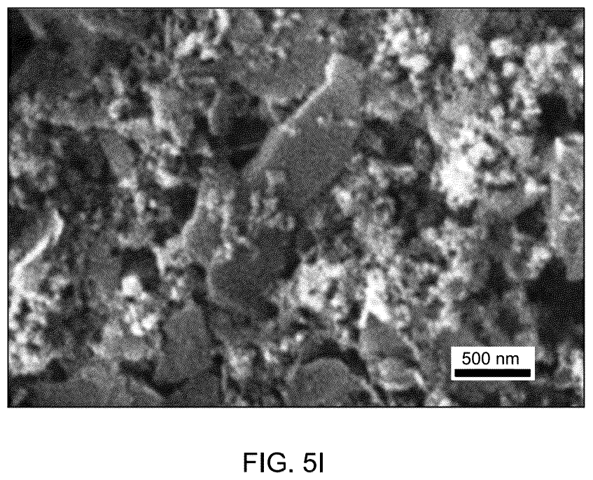

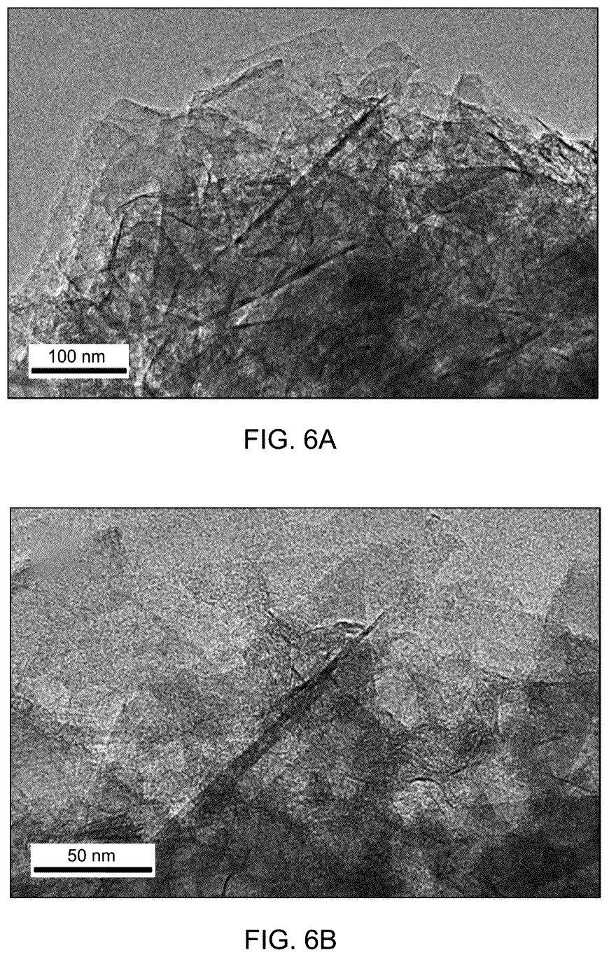

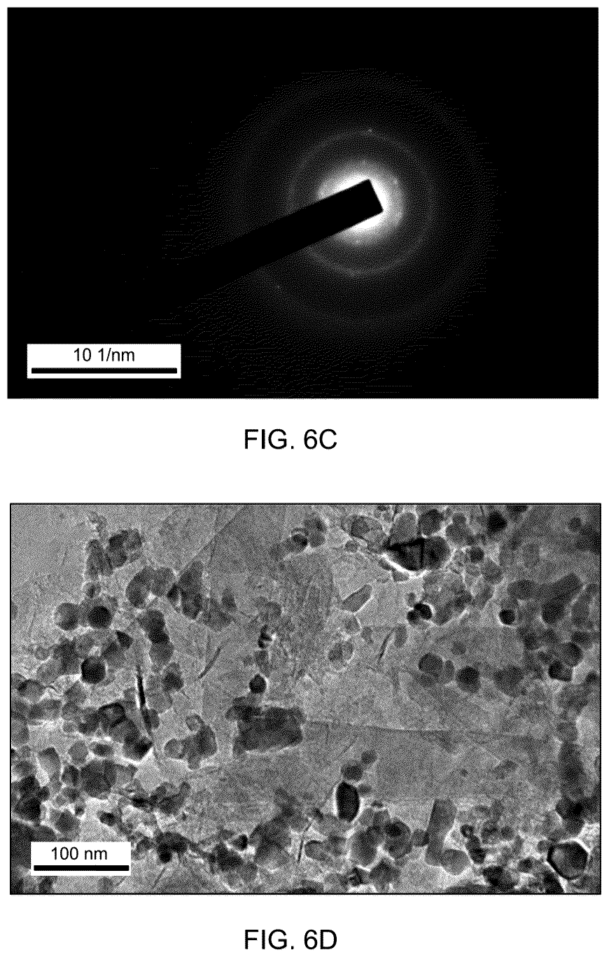

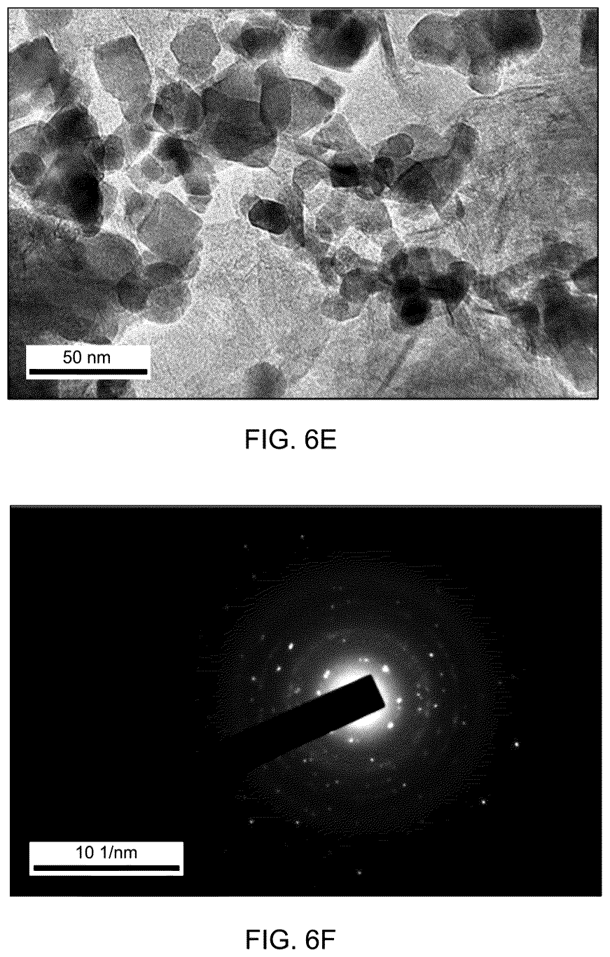

FIGS. 5A-5C show SEM images of the Al₂O₃ support, FIGS. 5D-5F show SEM images of GS-coated Al₂O₃ support, and FIGS. 5G-5I show SEM images of TiO₂@GS-coated Al₂O₃ ceramic membranes at three different magnifications. When comparing the images of the Al₂O₃ support (FIG. 5C) and GS-coated Al₂O₃ support at the highest resolution in FIG. 5F, the flake-like shapes of graphene sheets are evident. Further, by comparing the highest resolved image of GS-coated Al₂O₃ support and TiO₂@GS-coated Al₂O₃ ceramic membrane, the dispersion of TiO₂ nanoparticles on the graphene sheets is evident. The observed changes in the morphology of the modified membranes are also seen in the TEM images of GS-coated Al₂O₃ support, as shown in FIGS. 6A-6B, and TiO₂@GS-coated Al₂O₃ ceramic membrane, as shown in FIGS. 6D-6E. The sheet-like shape of graphene and the spherical shape of the TiO₂ nanoparticles are observed in the TEM images. In addition to this, FIG. 6C and FIG. 6F show the SAED patterns of GS-coated Al₂O₃ support and TiO₂@GS-coated Al₂O₃ ceramic membrane, where the observed diffraction rings correspond to XRD peaks, as shown in FIG. 3B and FIG. 3C.

### Example 6: Elemental Characterization of the Membranes

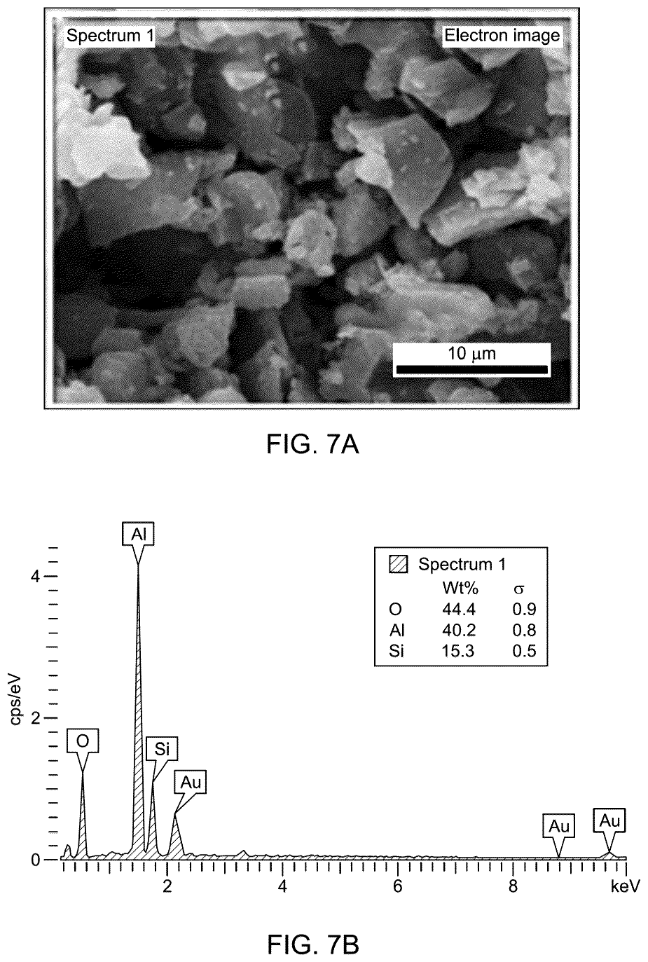

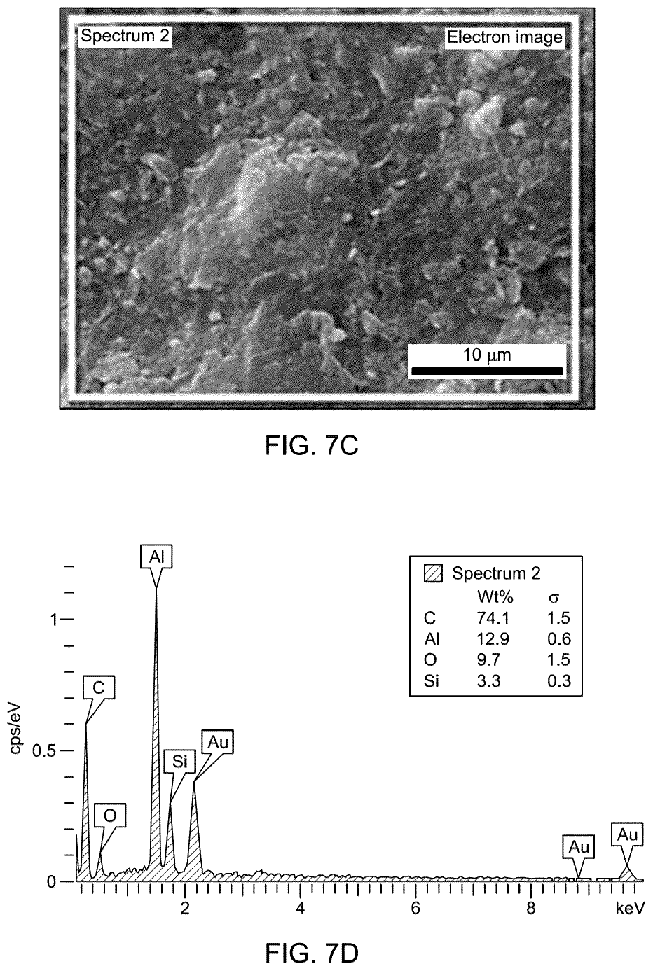

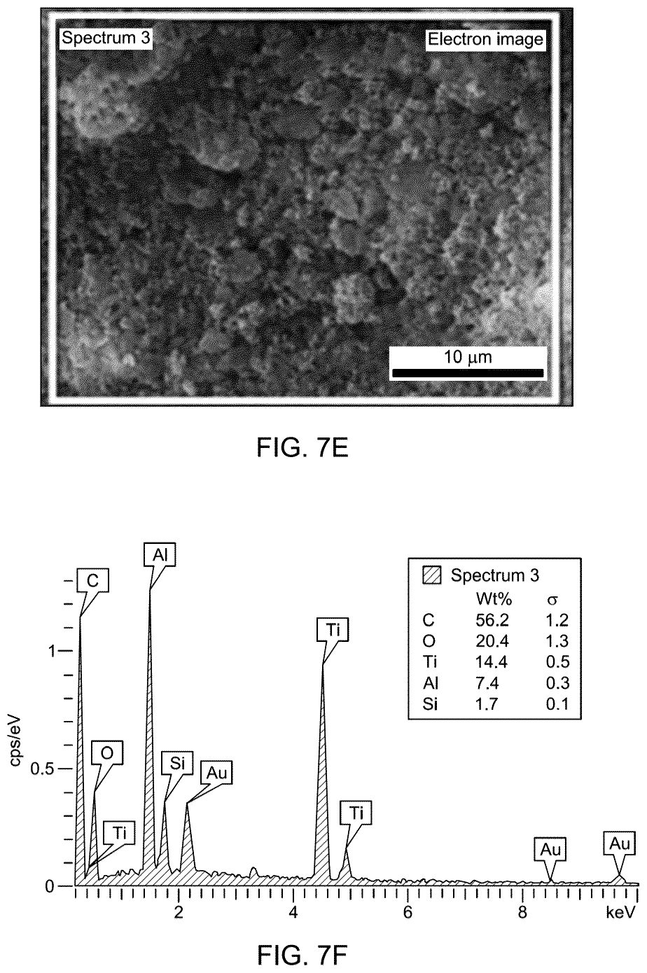

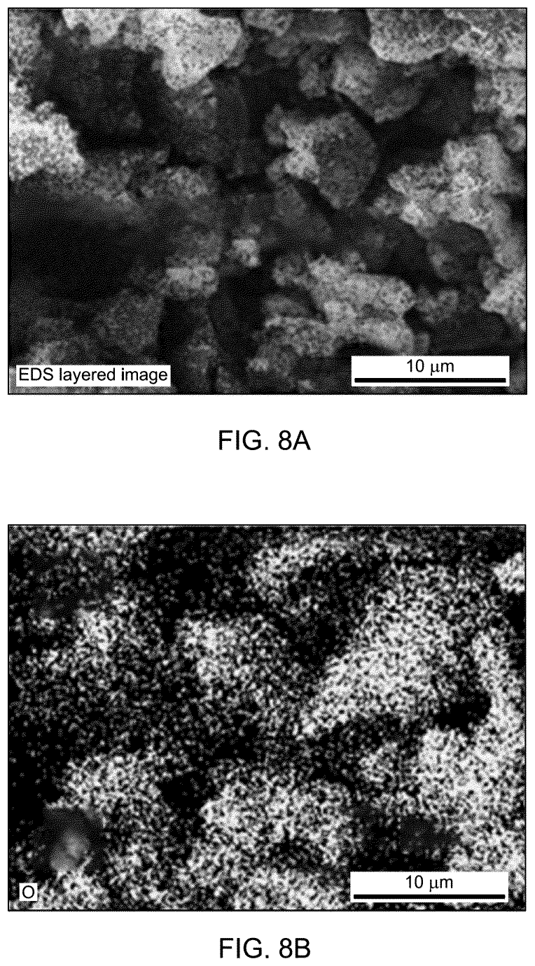

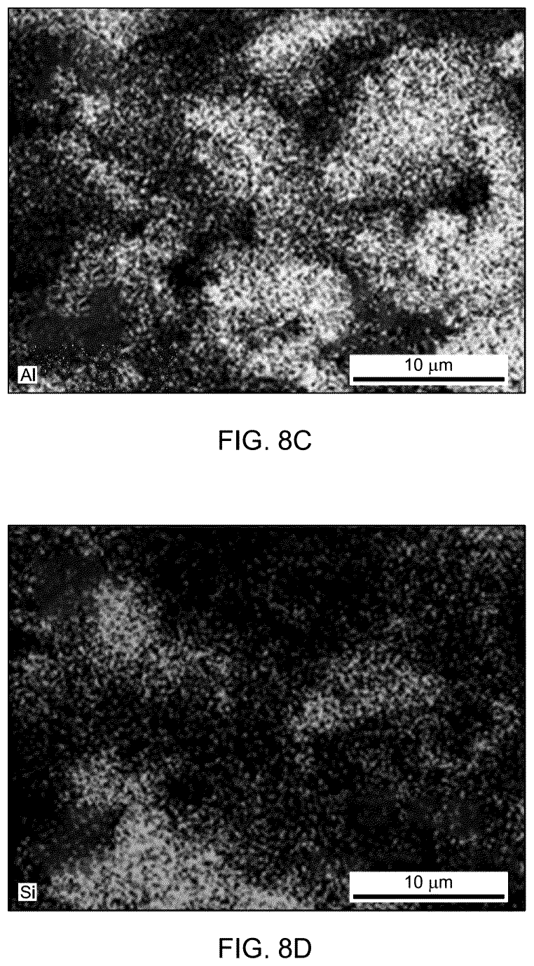

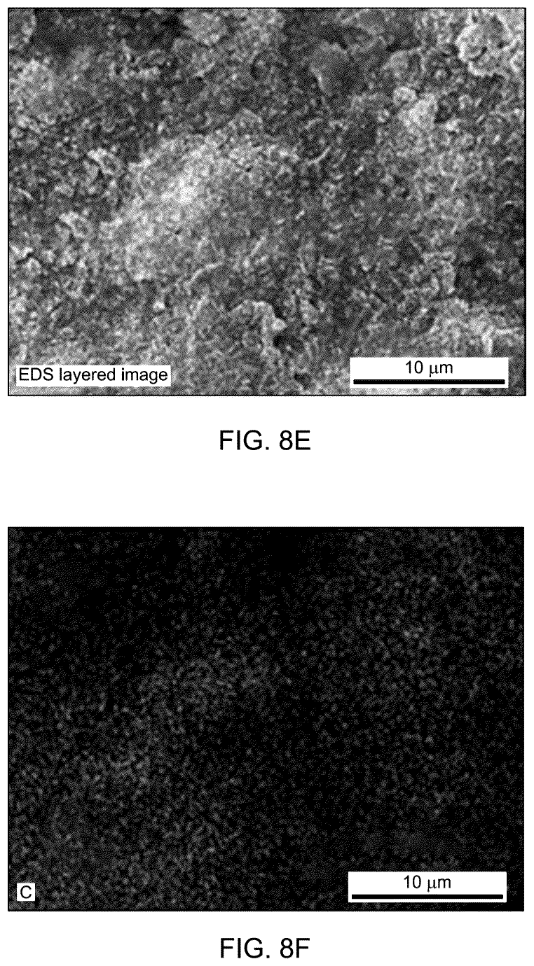

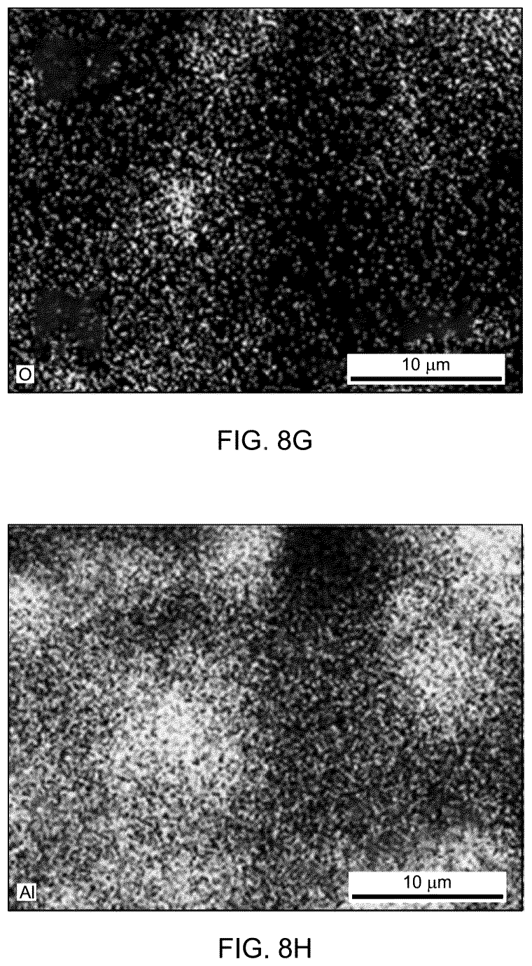

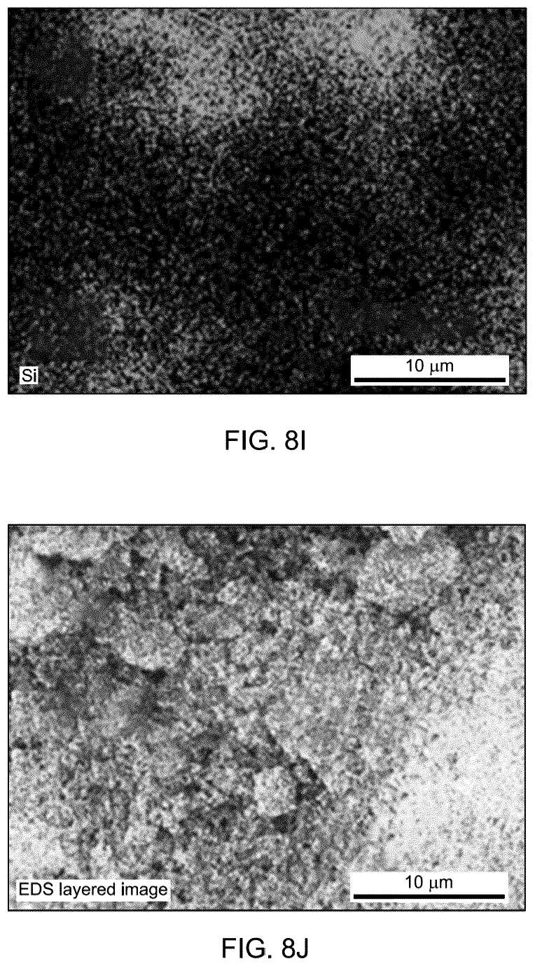

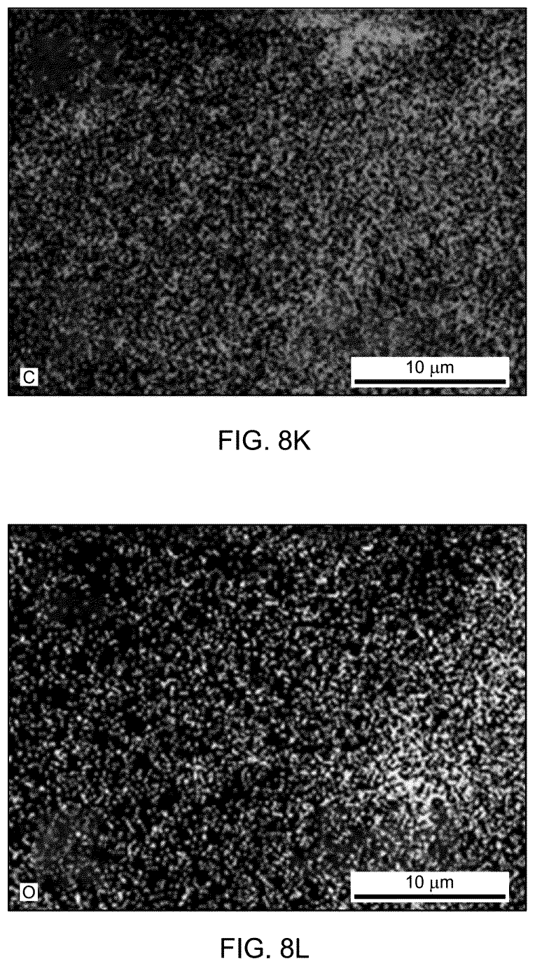

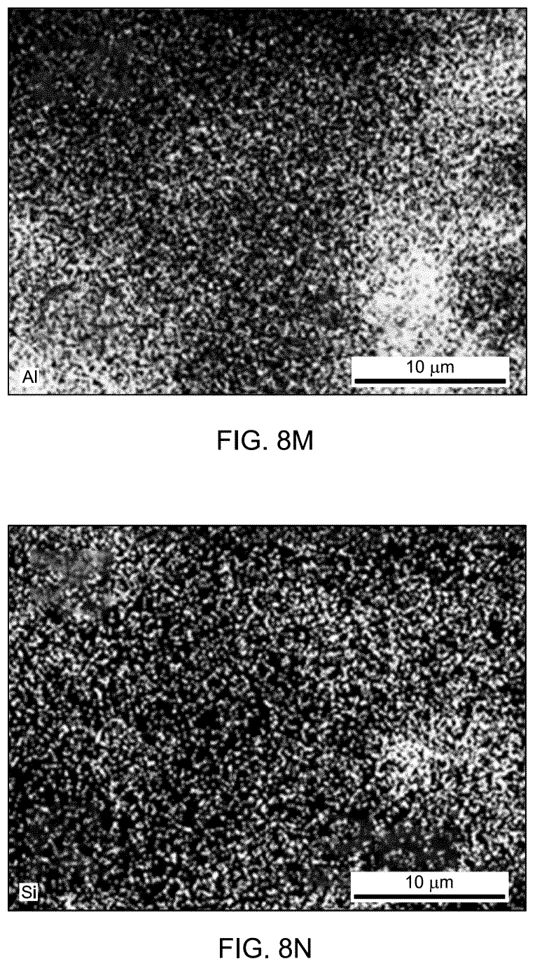

To substantiate proper loading and anchoring of the coated materials on the Al₂O₃ support, electron imaging and EDX elemental analysis of the Al₂O₃ support (FIG. 7A & FIG. 7B), the GS-coated Al₂O₃ support (FIG. 7C & FIG. 7D), and TiO₂@GS-coated Al₂O₃ ceramic membrane was performed. The insets of FIG. 7B, FIG. 7D, and FIG. 7F depict the percentage of detected elements corresponding to each EDX image of the Al₂O₃ support, the GS-coated Al₂O₃ support, and TiO₂@GS-coated Al₂O₃ ceramic membrane, respectively. FIGS. 8A-8O show the EDS elemental mapping of the Al₂O₃ support, the GS-coated Al₂O₃ support, and TiO₂@GS-coated Al₂O₃ ceramic membrane The layered elemental mapping images (FIG. 8A, FIG. 8E, and FIG. 8J) are the combined representation of all the elements in the respective supports and membrane. EDS mapping for the Al₂O₃ support reveals O, Al, and Si, as shown in FIG. 8B, FIG. 8C, and FIG. 8D, respectively. Elements present in the GS-coated Al₂O₃ support include C, O, Al, and Si, as shown in FIG. 8F, FIG. 8G, FIG. 8H, and FIG. 8I, respectively. Elements present in the TiO₂@GS-coated Al₂O₃ ceramic membrane include C, O, Al, Si, and Ti, as shown in FIG. 8K, FIG. 8L, FIG. 8M, FIG. 8N, and FIG. 8O, respectively.

### Example 7: Surface Wettability of Modified Al₂O₃ Ceramic Membrane

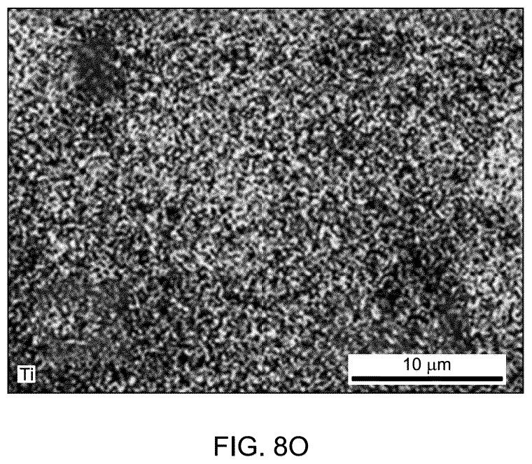

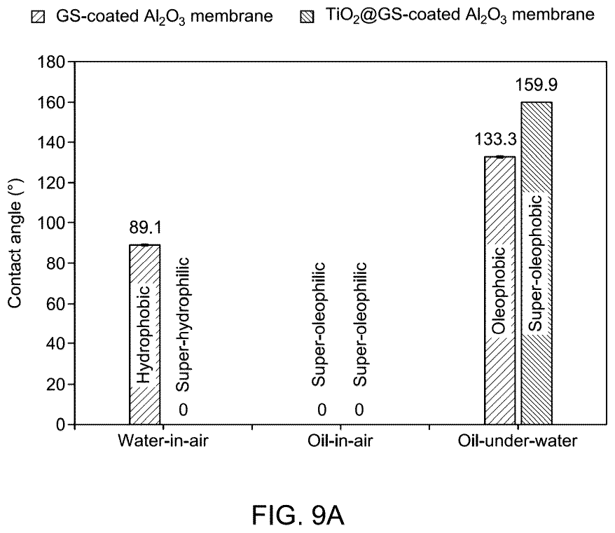

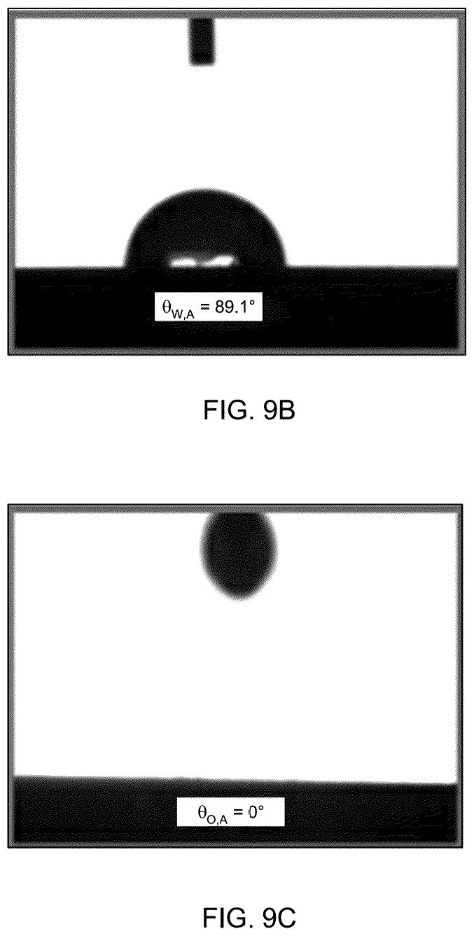

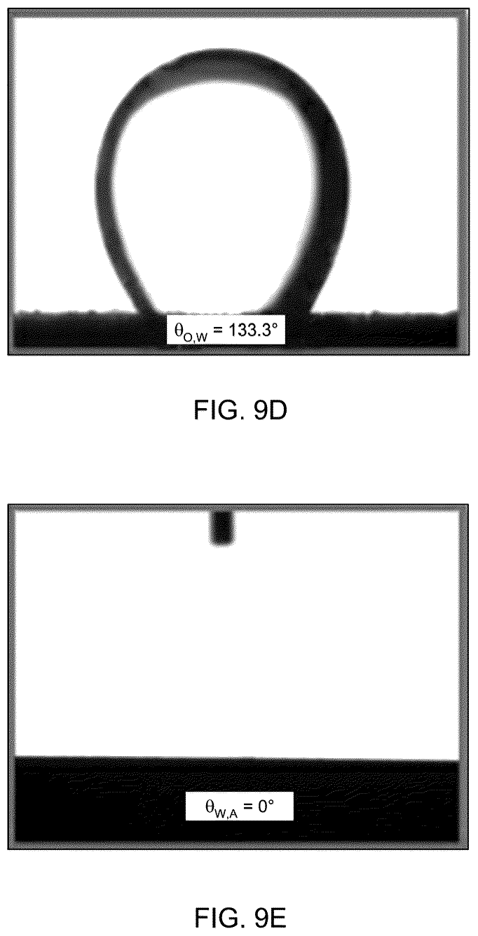

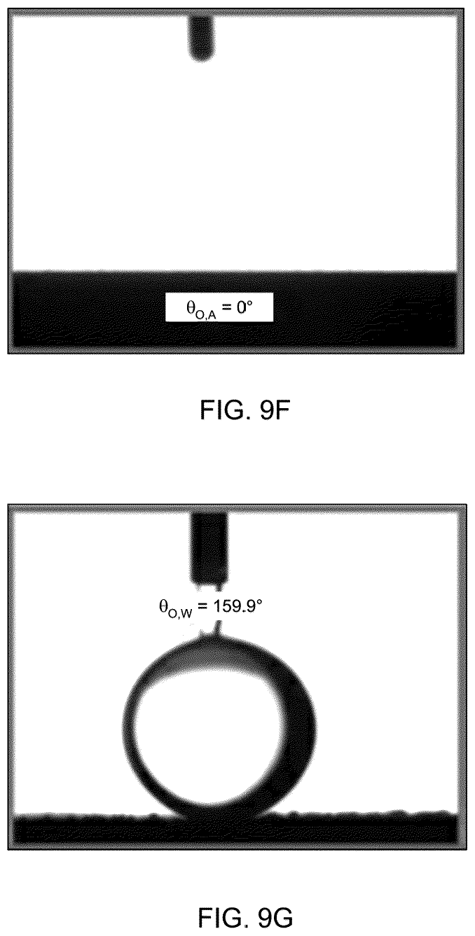

In addition to the membrane pore size and applied trans-membrane pressure of the dead-end filtration system, the oil and water wettability on the membrane surface influences the permeating medium (oil or water), the permeation flux, and the oil-water separation efficiency. FIG. 9A shows the surface wettability of the GS-coated Al₂O₃ support and the TiO₂@GS-coated Al₂O₃ ceramic membrane in air and water environments, in terms of static contact angles. Photographic images of the water and oil drops on the GS-coated Al₂O₃ support and the TiO₂@GS-coated Al₂O₃ ceramic membrane surface are shown in FIGS. 9B-9G. The GS-coated Al₂O₃ support surface in FIG. 9A shows hydrophobicity and superoleophilicity in air with contact angles of θ_{WA}=89±1°and θ_{OA}=0°, respectively. Underwater the surface switched to oleophobic with contact angle of θ_{OW}=113±1°. When the GS-coated Al₂O₃ support is supplemented with TiO₂, the water and oil-wetting behaviors of the surface change, and the TiO₂@GS-coated Al₂O₃ ceramic membrane becomes superhydrophilic and superoelophilic in air with contact angles of θ_{WA}=θ_{OA}=0°. Underwater the surface of the TiO₂@GS-coated Al₂O₃ ceramic membrane is superoleophobic with contact angle θ_{OW}=16±1°.

Graphene is a two-dimensional basal plane exfoliated from a three-dimensional graphite structure. In graphene, each carbon atom is covalently bonded to two neighboring carbon atoms through sp² hybridized orbitals. Generally, two atoms bonded through sp² hybridization show a difference in electronegativity, leading to a net electric dipole moment; however, in graphene, due to C—C bonding, there is no difference in the electronegativity between the bonded carbon atoms, which leaves the graphene surface non-polar (zero dipole moment). Due to the non-polar nature of the graphene surface, the surface energy of the GS-coated Al₂O₃ support is too low to dominate adhesive forces to overcome the cohesive forces of highly polar water droplets. This theory explains the observed hydrophobicity of the GS-coated Al₂O₃ support. Switching of surface wettability of the TiO₂@GS-coated Al₂O₃ support from hydrophobic to superhydrophilic may be explained by the electric nature of TiO₂. In the TiO₂ molecule, one Ti⁴⁺ cation is ionically bonded to two O²⁻ anions, making TiO₂ ionically charged, and leading to an enhanced surface energy of the TiO₂@GS-coated Al₂O₃ ceramic membrane. When water droplets come in contact with the TiO₂@GS-coated Al₂O₃ ceramic membrane, the adhesive force between the surface and the water molecule subdues the cohesive force of the water droplet, resulting in the total spreading of water on the membrane surface (superhydrophilic). The observed strong oil affinity on the GS-coated Al₂O₃ support and the TiO₂@GS-coated Al₂O₃ ceramic membrane in an air environment may be attributed to the lower surface tension of oil than that of water and the consequent dominance of adhesive force of the oil droplet on the surface over the cohesive force of the oil droplet.

The underwater oleophobicity of the GS-coated Al₂O₃ support may be explained by the combined water-oil-air-solid system. According to the modified Young's equation for a three-interface system, the oil-in-water contact angle q_{OW} may become large due to the combined effect of a low surface oil-in-air contact angle (q_{OA}) and a low surface-oil-air interfacial energy (γ_{OW}). Conversely, in the TiO₂@GS-coated Al₂O₃ ceramic membrane, the membrane water-in-air contact angle (θ_{WA}) and membrane oil-in-air contact angle (θ_{OA}) are close to zero. The membrane oil-in-water contact angle θ_{OW} becomes high (underwater superoleophobic) due to the surface-water-air interfacial energy (γ_{WA}) being more than surface-oil-air interfacial energy (γ_{OA}) and accompanied by a low surface-oil-water interfacial energy (γ_{OW}).

The surface roughness of the TiO₂@GS-coated Al₂O₃ ceramic membrane contributes to modifying the inherent wetting behavior of the surface, a property which is not considered by the basic Young's equation. Considering the extent of the surface roughness, there are three possible wetting states: the Wenzel state, where the liquid completely penetrates into the pits of the rough surface and the smooth surface Young's contact angle changes depending on the extent of the surface roughness; the Cassie Baxter state, where the trapped air prevents the liquid from penetrating the pits of the rough surface and liquid hovers on the membrane surface and the smooth surface Young's contact angle changes proportionally to the extent of surface roughness and the fraction of surface in contact with water. The third kind of surface is the transition state, which is a combination of both Wenzel and Cassie Baxter states. The TiO₂@GS-coated Al₂O₃ ceramic membrane surface is super hydrophilic in air, indicating that water can penetrate into the pits of the rough surface (Wenzel state). Due to the low oil-water interfacial energy, the trapped water prevents the oil from penetrating the pits, and oil hovers on the trapped water, partially supported by the tip of the surface (Cassie Baxter state) This condition makes the TiO₂@GS-coated Al₂O₃ ceramic membrane surface superoleophobic under the water.

### Example 8: Oil-In-Water Separation Performance of TiO₂@GS-Coated Al₂O₃ Ceramic Membrane

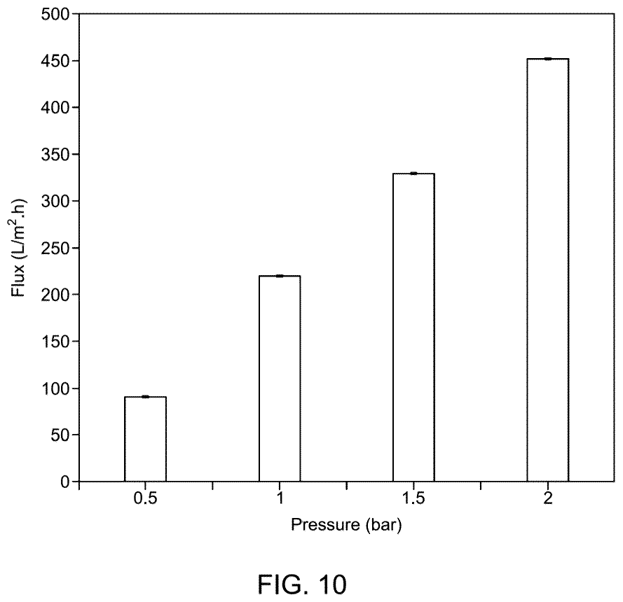

The GS-coated Al₂O₃ support is hydrophobic and oleophilic in air. With this contrasting combination of oil and water wettability, oil in an oil-in-water emulsion is expected to permeate through the medium and retain the water phase on the feed side; however, the underwater oleophobicity of the GS-coated Al₂O₃ support prevents the oil from selectively permeating through the membrane. When trans-membrane pressure is increased, both oil and water phases are passed together through the membrane, which is a failure of the oil-water separation process. As such, pure graphene coating on the Al₂O₃ ceramic membrane is not suitable for separating oil in an oil-in-water emulsion; however, the favorable two-dimensional structure of graphene networks for oil-water separation is harnessed by incorporating wetting conditions on the graphene surface by introducing TiO₂ on the graphene-based coating material (TiO₂@GS-coated Al₂O₃ ceramic membrane). FIG. 10 shows the flux, J, (L m⁻² h⁻¹) of permeated water at different trans-membrane pressures when the TiO₂@GS-coated Al₂O₃ ceramic membrane is used as a filter element in a dead-end filtration system. In FIG. 10, pure water is used as the feed solution to understand dependence of permeate flux on trans-membrane pressure. As can be seen from FIG. 10, the higher the trans-membrane pressure, the higher the permeate flux. The permeate flux reached as high as 450 L m⁻² h⁻¹ at a trans-membrane pressure of 2 bar. A similar trend in permeate flux is observed with different types of oil and varying concentrations of oil in oil-in-water emulsions. Oil-water separation efficiency remains constant across all workable trans-membrane pressures, which indicates surface wettability, not trans-membrane pressure, influences the quality of oil-water separation, provided the operation is within a workable trans-membrane pressure.

There is a limiting maximum workable trans-membrane pressure, above which the membrane loses its oil rejection characteristics. The limiting value of the maximum workable trans-membrane pressure may be greater if there is an opposing pressure from the oil-water interfacial forces. The opposing pressure due to oil-water interfacial forces increases with increased surface-oil-water interfacial energy (γ_{OW}), increased surface oil-in-water contact angle (θ_{OW}), and decreased pore diameter. The possibility of increasing the maximum workable trans-membrane pressure to achieve a high permeate flux is an advantage of establishing underwater superoleophobicity in the TiO₂@GS-coated Al₂O₃ ceramic membrane. In the TiO₂@GS-coated Al₂O₃ ceramic membrane, the characteristic of the TiO₂ is establishing a high degree of water affinity and oil repellency for selective oil-passing filtration. In addition, TiO₂ brings about better underwater oil repellency, which contributes to the potential of the membrane to withstand high trans-membrane pressure to yield high permeate flux with good oil-water separation efficiency.

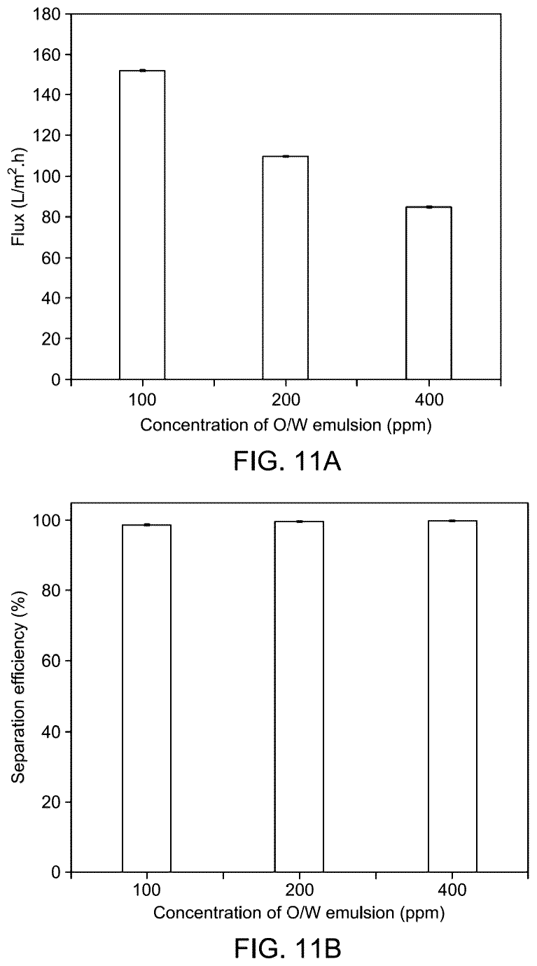

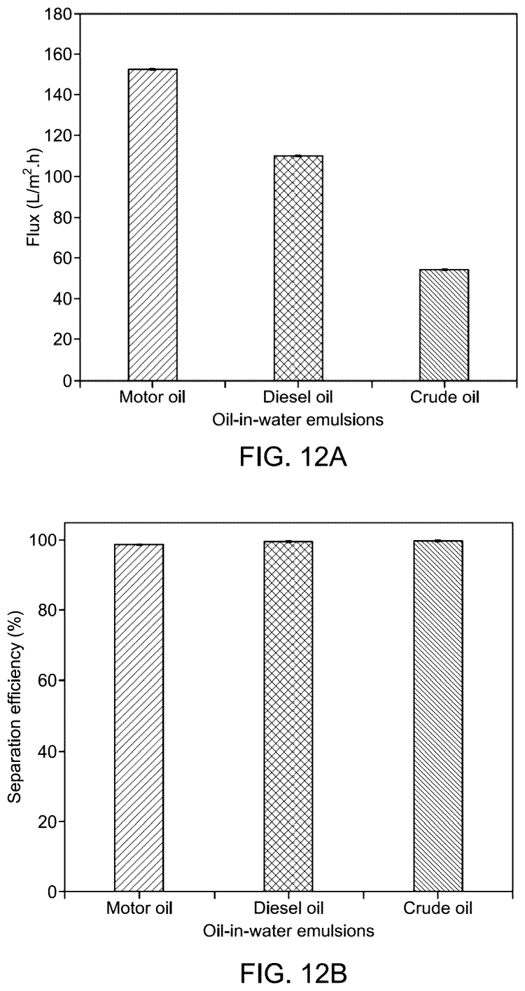

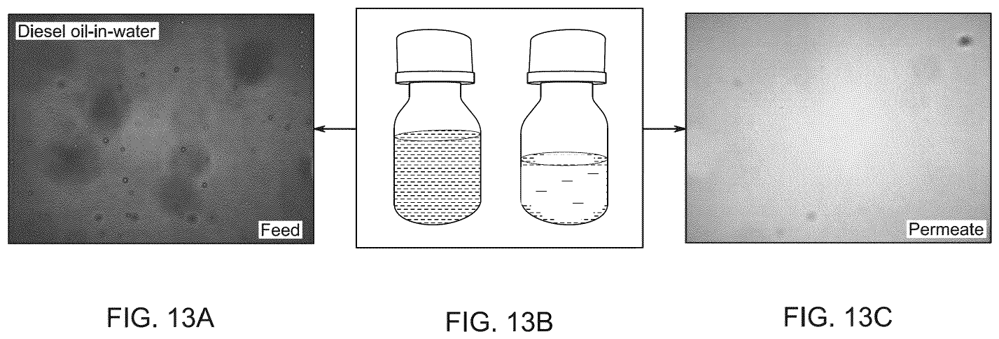

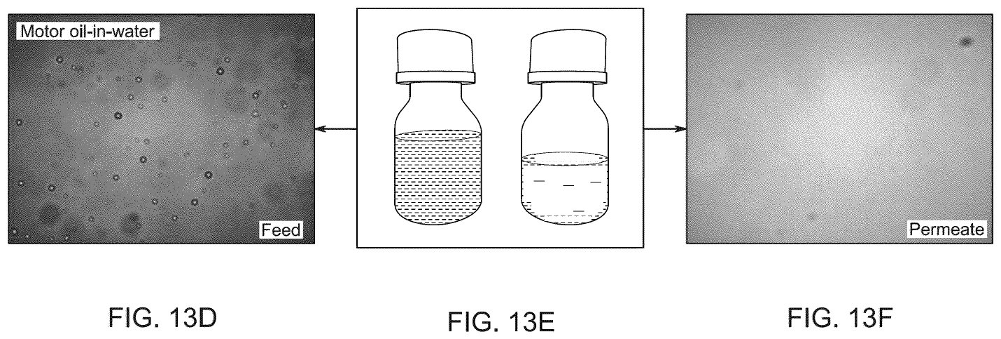

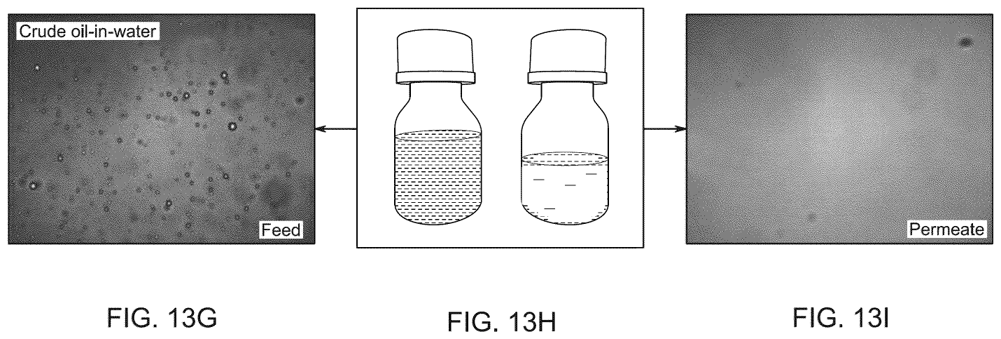

The concentration of the dispersed oil in the oil-in-water emulsion and the kinematic viscosity of the oil are factors that affect the permeate flux and the oil-water separation efficiency. FIG. 11A and FIG. 11B show the permeate flux and oil-water separation efficiency of the TiO₂@GS-coated Al₂O₃ ceramic membrane at different oil concentrations in oil-in-water emulsion at a fixed trans-membrane pressure of 1 bar, respectively. As seen in FIGS. 11A-11B, flux reduces with increased oil concentration and oil-water separation efficiency remains constant for all oil concentrations. When the oil concentration in the emulsion becomes higher, the osmotic pressure that counters the applied trans-membrane pressure plays a role, and the net effect of the osmotic pressure is the reduction of trans-membrane pressure which results in the reduction of permeate flux. FIG. 12A and FIG. 12B show the permeate flux and oil-water separation efficiency of the TiO₂@GS-coated Al₂O₃ ceramic membrane for different kinds of oil (with different kinematic viscosity) at a fixed trans-membrane pressure of 1 bar, respectively. The permeate flux for the different oils in FIG. 12A-FIG. 12B varies but the oil-water separation efficiency remains constant. This variation in flux is due to the inverse dependence of flux on kinematic viscosity. Among the three oils used, motor oil has the lowest kinematic viscosity, crude oil has the highest value, and diesel oil has an intermediate value. The relationship of the inverse dependence of flux on the kinematic viscosity of a liquid is reflected in the permeate flux in FIG. 12A. Digital images of the oil-in-water emulsions and those of the permeate are presented in FIGS. 13A-13I. The images provide visible confirmation for the efficiency of the water separation process using the TiO₂@GS-coated Al₂O₃ ceramic membrane.

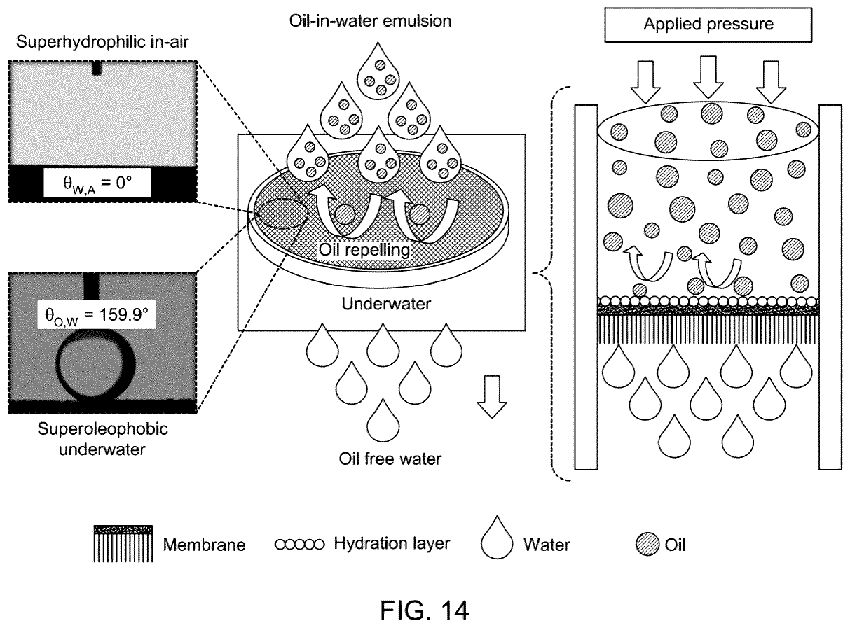

The mechanism of surface wettability-based remediation of water from an oil-in-water emulsion using the TiO₂@GS-coated Al₂O₃ ceramic membrane in a dead-end oil water filtration system is shown in FIG. 14. The wettability of the TiO₂@GS-coated Al₂O₃ ceramic membrane resulted in a rejection of oil in a water medium and high-water affinity, as indicated in the insets of FIG. 14. Another aspect of the membrane surface is the ability to withstand higher trans-membrane pressure to separate the oil from the oil-in-water emulsion. When the oil-in-water emulsion is poured into a feed side of the membrane under a certain pressure, the oil droplets in the oil-in-water emulsion experience a strong repulsion by the membrane surface and are rejected and repelled away from the surface. Simultaneously, the water medium is attracted and passed through the membrane pores. The ability of the membrane to withstand higher pressure before failing its functionality of oil-water separation facilitates the high permeate flux.

Aspects of the present disclosure provide a TiO₂@GS-coated Al₂O₃ ceramic membrane. The membrane was fabricated by spray coating a synthesized TiO₂@GS composite material on an Al₂O₃ ceramic support. Initially, graphene was ultrasonically exfoliated from graphite and ultrasonically composited with TiO₂ nanoparticles. The TiO₂@GS-coated Al₂O₃ ceramic membrane exhibited superhydrophilicity characteristics and underwater superoleophobicity characteristics with water-in-air contact angle (q_{WA}) close to 0° and oil-in-water contact angle (θ_{WA}) of 160±1°. The fabricated membrane was used in a dead-end oil-water filtration system, and the oil-water separation efficiency was as high as 99 % for separating oil and water from an oil-in-water emulsion. The altered surface wettability of the membrane helped to increase the maximum workable pressure, which enabled a permeate flux of J=150 L m⁻² h⁻¹. The water-passing nature of the membrane reduced the hassle of oil clogging in the pores and increased the recyclability of the membrane.

Numerous modifications and variations of the present disclosure are possible in light of the above teachings. It is therefore to be understood that within the scope of the appended claims, the disclosure may be practiced otherwise than as specifically described herein.

1: A membrane, comprising:
an aluminum oxide ceramic support coated with a layer comprising graphene flakes and titanium dioxide nanoparticles,
wherein the titanium dioxide nanoparticles are dispersed on the graphene flakes,
wherein the titanium dioxide nanoparticles dispersed on the graphene flakes are in the form of spherical particles,
wherein the spherical particles have a diameter of 1 to 15 μm,
wherein the graphene flakes have a longest dimension of 0.2 to 5 μm.

2: The membrane of claim 1, wherein the membrane is made by a process comprising:
sonicating graphite paint for 30 to 90 minutes to form a graphene dispersion;
mixing titanium dioxide nanoparticles with a polar organic solvent to form a titanium dioxide dispersion;
sonicating the graphene dispersion and the titanium dioxide dispersion for 20 to 40 minutes to form a titanium dioxide nanoparticle loaded graphene sheet nanocomposite dispersion; and
spray coating the titanium dioxide nanoparticle loaded graphene sheet nanocomposite dispersion on the aluminum oxide ceramic support to form the membrane.

3: The membrane of claim 2, wherein the spray coating is done with a spray gun having a 0.7 to 0.8 mm nozzle diameter.

4: The membrane of claim 3, wherein the spray gun is under nitrogen pressure of 160 to 180 kPa.

5: The membrane of claim 3, wherein the aluminum oxide support is at a distance of 10 to 30 cm from the nozzle.

6: The membrane of claim 1, wherein the titanium dioxide nanoparticles have an average diameter of 10 to 70 nm.

7: The membrane of claim 1, wherein the membrane comprises 50 to 60 percent by weight (wt. %) carbon, 15 to 25 wt. % oxygen, 10 to 20 wt. % titanium, 5 to 10 wt. % aluminum, and 1 to 3 wt. % silicon based on a total weight of the membrane.

8: The membrane of claim 1, wherein the membrane has a water contact angle in air of 0.0 to 0.1°.

9: The membrane of claim 1, wherein the membrane has an oil contact angle in air of 0.0 to 0.1°.

10: The membrane of claim 1, wherein the membrane has an oil contact angle in water of 158 to 162°.

11: The membrane of claim 1, wherein the membrane has a pure water flux of 210 to 230 L m⁻² h⁻¹ at a pressure of 1 bar.

12: A method of filtration, comprising:
contacting the membrane of claim 1 with a mixture,
wherein the mixture comprises one or more oils and water,
passing a filtrate through the membrane; and
collecting the filtrate,
wherein the filtrate has a lower amount of the one or more oils than the mixture.

13: The method of claim 12, wherein the one or more oils are present in the mixture at a concentration of 50 to 500 ppm.

14: The method of claim 13, wherein the one or more oils are present in the mixture at a concentration of 100 ppm and the membrane has a flux of 140 to 160 L m⁻² h⁻¹ at a pressure of 1 bar.

15: The method of claim 12, wherein the one or more oils are selected from a group consisting of motor oil, diesel oil, and crude oil.

16: The method of claim 12, further comprising:
applying a pressure to the membrane.

17: The method of claim 12, wherein a hydration layer forms on a surface of the membrane.

18: The method of claim 15, wherein the one or more oils is motor oil, and the membrane has a flux of 140 to 160 L m⁻² h⁻¹ at a pressure of 1 bar and a concentration of motor oil of 100 ppm.

19: The method of claim 15, wherein one or more oils is diesel oil, and the membrane has a flux of 100 to 120 L m⁻² h⁻¹ at a pressure of 1 bar and a concentration of diesel oil of 100 ppm.

20: The membrane of claim 1, wherein the membrane has an oil from water separation efficiency of 97 to 100 percent based on an initial weight of the oil.
